(19) United States
(12) Patent Application Publication
(10) Pub. No.: US 2024/0259131 A1
(43) Pub. Date: Aug. 1, 2024

(54) METHOD FOR TRANSMITTING/RECEIVING SIGNAL IN WIRELESS COMMUNICATION SYSTEM BY USING AUTO ENCODER, AND APPARATUS THEREFOR

(71) Applicant: LG ELECTRONICS INC., Seoul (KR)

(72) Inventors: Bonghoe KIM, Seoul (KR); Jongwoong SHIN, Seoul (KR)

(73) Assignee: LG ELECTRONICS INC., Seoul (KR)

(21) Appl. No.: 18/290,531

(22) PCT Filed: May 21, 2021
(86) PCT No.: PCT/KR2021/006365

§ 371 Date: Nov. 14, 2023

(51) Int. Cl. H04L 1/00; G06N 3/0455

(52) U.S. Cl. CPC H04L 1/0033; G06N 3/0455; H04L 1/0036

(57) ABSTRACT

The present specification provides a method for transmitting/receiving a signal in a wireless communication system by using an auto encoder. More specifically, the method performed by means of a transmission end comprises the steps of: encoding at least one input data block on the basis of a pre-trained transmission end encoder neural network; and transmitting a signal to a reception end on the basis of the encoded at least one input data block, wherein each of activation functions included in the transmission end encoder neural network receives only some of all input values that can be input into each of the activation functions.

### TECHNICAL FIELD

The present disclosure is for transmitting and receiving a signal based on an auto encoder, and more specifically, relates to a method of transmitting and receiving a signal in a wireless communication system based on an auto encoder, and an apparatus therefor.

### BACKGROUND ART

Wireless communication systems are being widely deployed to provide various types of communication services such as voice and data. In general, a wireless communication systems is a multiple access system that can support communication with multiple users by sharing available system resources (bandwidth, transmission power, etc.). Examples of multiple access systems include Code Division Multiple Access (CDMA) systems, Frequency Division Multiple Access (FDMA) systems, Time Division Multiple Access (TDMA) systems, Space Division Multiple Access (SDMA) systems, Orthogonal Frequency Division Multiple Access (OFDMA) systems, Single Carrier Frequency Division Multiple Access (SC-FDMA) systems, and Interleave Division Multiple Access (IDMA) system, etc.

### DISCLOSURE

### Technical Problem

The purpose of the present disclosure is to provide a method of transmitting and receiving a signal in a wireless communication system based on an auto encoder, and an apparatus therefor.

Additionally, the purpose of the present disclosure is to provide a method of transmitting and receiving a signal with high efficiency in a wireless communication system, and an apparatus therefor.

Additionally, the purpose of the present disclosure is to provide a method of configuring a neural network for transmitting and receiving a signal with high efficiency in a wireless communication system, and an apparatus therefor.

Additionally, the purpose of the present disclosure is to provide a method of reducing complexity of neural network configuration for transmitting and receiving a signal with high efficiency in a wireless communication system, and an apparatus therefor.

Additionally, the purpose of the present disclosure is to provide a signaling method between a transmitter and a receiver in a wireless communication system based on an auto encoder, and an apparatus therefor.

Technical objects to be achieved by the present disclosure are not limited to the aforementioned technical objects, and other technical objects not described above may be evidently understood by a person having ordinary skill in the art to which the present disclosure pertains from the following description.

### Technical Solution

The present disclosure provides a method for transmitting and receiving a signal in a wireless communication system based on an auto encoder, and an apparatus therefor.

More specifically, in the present disclosure, a method for transmitting a signal in a wireless communication system based on an auto encoder, the method performed by a transmitter comprises encoding at least one input data block based on a pre-trained transmitter encoder neural network; and transmitting the signal to a receiver based on the encoded at least one input data block, wherein each of activation functions included in the transmitter encoder neural network receives only some input values of all input values that can be input into each of the activation functions, the transmitter encoder neural network is configured based on a neural network configuration unit that receives two input values and outputs two output values, the neural network configuration unit includes a first activation function that receives both of the two input values and a second activation function that receives only one of the two input values, one of the two output values is output by multiplying the two input values by a weight applied to each of two paths through which the two input values are input into the first activation function, respectively and, applying the first activation function to sum of the two input values each multiplied by the weight, and the other one of the two output values is output by multiplying the one input value by a weight applied to a path through which the one input value is input into the second activation function and, and applying the second activation function to one input value multiplied by the weight.

In addition, in the present disclosure, a number of the neural network configuration unit configuring the transmitter encoder neural network may be determined based on a number of the at least one input data block.

In addition, in the present disclosure, when the number of the at least one input data block is 2K, the transmitter encoder neural network may be configured as K layers, the K layers each may be configured as 2K−1 neural network units, and the K may be an integer of 1 or more.

In addition, in the present disclosure, the number of the neural network configuration unit configuring the transmitter encoder neural network may be K*2k−1.

In addition, in the present disclosure, the first activation function and the second activation function may be the same function.

In addition, in the present disclosure, an output value of each of the first activation function and the second activation function may be determined as one of a specific number of quantized values.

In addition, in the present disclosure, the first activation function and the second activation function may be different functions,

$${f}_{2} ( x ) = x \qquad [ equation ]$$

The second activation function may be a function that satisfies the above equation.

In addition, the present disclosure may further comprise training the transmitter encoder neural network and a receiver decoder neural network configuring the auto encoder.

In addition, the present disclosure may further comprise transmitting information for decoding in the receiver decoder neural network to the receiver based on the training being performed at the transmitter.

In addition, the present disclosure may further comprise receiving structural information related to a structure of the receiver decoder neural network from the receiver, based on the structural information, the information for decoding in the receiver decoder neural network may include (i) receiver weight information used for the decoding in the receiver decoder neural network, or (ii) transmitter weight information for the receiver weight information and for weights used for encoding in the transmitter encoder neural network.

In addition, in the present disclosure, based on that the structure of the receiver decoder neural network indicated by the structure information is a first structure configured to receive only some input values of all input values that each of receiver activation functions included in the receiver decoder neural network can be input to each of the receiver activation functions, the information for decoding in the receiver decoder neural network may include the receiver weight information, and based on that the structure of the receiver decoder neural network indicated by the structure information is a second structure configured based on a plurality of decoder neural network configuration units, which is each performing decoding, for some data blocks configuring an entire data block received from the receiver decoder neural network, the information for decoding in the receiver decoder neural network may include the receiver weight information and the transmitter weight information.

In addition, in the present disclosure, based on the training, a value of the weight applied to each of the two paths through which the two input values are input into the first activation function and a value of the weight applied to the path through which the one input value is input into the second activation function may be trained.

In addition, in the present disclosure, a transmitter configured to transmit and receive a signal in a wireless communication system based on an auto encoder, the transmitter comprises a transmitter configured to transmit a wireless signal; a receiver configured to receive a wireless signal: at least one processor; and at least one memory operably connected to the at least one processor, and storing instructions for performing operations when on being executed by the at least one processor, wherein the operations includes encoding at least one input data block based on a pre-trained transmitter encoder neural network; and transmitting the signal to a receiver based on the encoded at least one input data block, wherein each of activation functions included in the transmitter encoder neural network receives only some input values of all input values that can be input into each of the activation functions, the transmitter encoder neural network is configured based on a neural network configuration unit that receives two input values and outputs two output values, the neural network configuration unit includes a first activation function that receives both of the two input values and a second activation function that receives only one of the two input values, one of the two output values is output by multiplying the two input values by a weight applied to each of two paths through which the two input values are input into the first activation function, respectively and, applying the first activation function to sum of the two input values each multiplied by the weight, and the other one of the two output values is output by multiplying the one input value by a weight applied to a path through which the one input value is input into the second activation function and, and applying the second activation function to one input value multiplied by the weight.

In addition, in the present disclosure, a method for receiving a signal in a wireless communication system based on an auto encoder, the method performed by a receiver comprises receiving a signal generated based on at least one input data block encoded based on a pre-trained transmitter encoder neural network from a transmitter; and decoding the received signal, wherein a structure of a receiver decoder neural network is one of (i) a first structure in which each of activation functions included in the receiver decoder neural network receives only some input values of all input values that can be input into each of the activation functions and (ii) a second structure configured based on a plurality of decoder neural network configuration units that each perform decoding for some data blocks configuring the encoded at least one input data block received from the receiver decoder neural network, the receiver decoder neural network configured in the first structure is configured based on a decoder neural network configuration unit that receives two input values and outputs two output values, the decoder neural network configuration unit includes two activation functions that receive both of the two input values, one of the two output values is output by multiplying the two input values by a weight applied to each of two paths through which the two input values are input into the first activation function, which is one of the two activation functions, respectively and, applying the first activation function to sum of the two input values each multiplied by the weight, and the other one of the two output values is output by multiplying the two input value by a weight applied to each of two path through which the two input value are input into the second activation function, which is one of the two activation functions, respectively and, applying the second activation function to sum of the two input values each multiplied by the weight.

In addition, in the present disclosure, a receiver configured to transmit and receive a signal in a wireless communication system based on an auto encoder, the receiver comprises a transmitter configured to transmit a wireless signal: a receiver configured to receive a wireless signal: at least one processor; and at least one computer memory operably connected to the at least one processor, and storing instructions for performing operations when being executed by the at least one processor, wherein the operations includes receiving a signal generated based on at least one input data block encoded based on a pre-trained transmitter encoder neural network from a transmitter; and decoding the received signal, wherein a structure of a receiver decoder neural network is one of (i) a first structure in which each of activation functions included in the receiver decoder neural network receives only some input values of all input values that can be input into each of the activation functions and (ii) a second structure configured based on a plurality of decoder neural network configuration units that each perform decoding for some data blocks configuring the encoded at least one input data block received from the receiver decoder neural network, the receiver decoder neural network configured in the first structure is configured based on a decoder neural network configuration unit that receives two input values and outputs two output values, the decoder neural network configuration unit includes two activation functions that receive both of the two input values, one of the two output values is output by multiplying the two input values by a weight applied to each of two paths through which the two input values are input into the first activation function, which is one of the two activation functions, respectively and, applying the first activation function to sum of the two input values each multiplied by the weight, and the other one of the two output values is output by multiplying the two input value by a weight applied to each of two path through which the two input value are input into the second activation function, which is one of the two activation functions, respectively and, applying the second activation function to sum of the two input values each multiplied by the weight.

In addition, in the present disclosure, a non-transitory computer readable medium (CRM) storing one or more instructions, wherein the one or more instruction being executed by the one or more processors cause a transmitter to encode at least one input data block based on a pre-trained transmitter encoder neural network; and transmit the signal to a receiver based on the encoded at least one input data block, wherein each of activation functions included in the transmitter encoder neural network receives only some input values of all input values that can be input into each of the activation functions, the transmitter encoder neural network is configured based on a neural network configuration unit that receives two input values and outputs two output values, the neural network configuration unit includes a first activation function that receives both of the two input values and a second activation function that receives only one of the two input values, one of the two output values is output by multiplying the two input values by a weight applied to each of two paths through which the two input values are input into the first activation function, respectively and, applying the first activation function to sum of the two input values each multiplied by the weight, and the other one of the two output values is output by multiplying the one input value by a weight applied to a path through which the one input value is input into the second activation function and, and applying the second activation function to one input value multiplied by the weight.

In addition, in the present disclosure, an apparatus comprising one or more memories and one or more processors functionally connected to the one or more memories, wherein the one or more processors control the apparatus to encode at least one input data block based on a pre-trained transmitter encoder neural network; and transmit the signal to a receiver based on the encoded at least one input data block, wherein each of activation functions included in the transmitter encoder neural network receives only some input values of all input values that can be input into each of the activation functions, the transmitter encoder neural network is configured based on a neural network configuration unit that receives two input values and outputs two output values, the neural network configuration unit includes a first activation function that receives both of the two input values and a second activation function that receives only one of the two input values, one of the two output values is output by multiplying the two input values by a weight applied to each of two paths through which the two input values are input into the first activation function, respectively and, applying the first activation function to sum of the two input values each multiplied by the weight, and the other one of the two output values is output by multiplying the one input value by a weight applied to a path through which the one input value is input into the second activation function and, and applying the second activation function to one input value multiplied by the weight.

### Advantageous Effects

The present disclosure has an effect of being able to transmit and receive a signal in a wireless communication system based on an auto encoder.

Additionally, the present disclosure has an effect of being able to transmit and receive a signal with high efficiency in a wireless communication system.

Additionally, the present disclosure has an effect of configuring an appropriate type of neural network for transmitting and receiving a signal with high efficiency in a wireless communication system.

Additionally, the present disclosure has an effect of reducing complexity of neural network configuration for transmitting and receiving a signal with high efficiency in a wireless communication system.

Additionally, the present disclosure has an effect of enabling efficient transmission and reception through a signaling method between a transmitter and a receiver in a wireless communication system based on an auto encoder.

Effects which may be obtained by the present disclosure are not limited to the aforementioned effects, and other technical effects not described above may be evidently understood by a person having ordinary skill in the art to which the present disclosure pertains from the following description.

### DESCRIPTION OF DRAWINGS

The accompany drawings, which are included to provide a further understanding of the present disclosure and are incorporated on and constitute a part of this specification illustrate embodiments of the present disclosure and together with the description serve to explain the principles of the present disclosure.

FIG. 1 illustrates physical channels and general signal transmission used in a 3GPP system.

FIG. 2 is a view showing an example of a communication structure providable in a 6G system applicable to the present disclosure.

FIG. 3 illustrates a structure of a perceptron to which the method proposed in the present specification can be applied.

FIG. 4 illustrates the structure of a multilayer perceptron to which the method proposed in the present specification can be applied.

FIG. 5 illustrates a structure of a deep neural network to which the method proposed in the present specification can be applied.

FIG. 6 illustrates the structure of a convolutional neural network to which the method proposed in the present specification can be applied.

FIG. 7 illustrates a filter operation in a convolutional neural network to which the method proposed in the present specification can be applied.

FIG. 8 illustrates a neural network structure in which a circular loop to which the method proposed in the present specification can be applied.

FIG. 9 illustrates an operation structure of a recurrent neural network to which the method proposed in the present specification can be applied.

FIGS. 10 and 11 illustrate an example of an auto encoder configured based on a transmitter and a receiver configured as a neural network.

FIG. 12 is a diagram illustrating an example of a polar code to help understand a method proposed in the present disclosure.

FIG. 13 is a diagram illustrating an example of a method of configuring a transmitter encoder neural network proposed in the present disclosure.

FIG. 14 is a diagram illustrating another example of a method of configuring a transmitter encoder neural network proposed in the present disclosure.

FIG. 15 is a diagram illustrating an example of a method of configuring a receiver decoder neural network proposed in the present disclosure.

FIG. 16 is a diagram illustrating another example of a method of configuring a receiver decoder neural network proposed in the present disclosure.

FIG. 17 is a diagram illustrating another example of a method of configuring a receiver decoder neural network proposed in the present disclosure.

FIG. 18 is a flowchart illustrating an example of a method of transmitting and receiving a signal in a wireless communication system based on an auto encoder proposed in the present disclosure.

FIG. 19 illustrates a communication system 1 applied to the present disclosure.

FIG. 20 illustrates wireless devices applicable to the present disclosure.

FIG. 21 illustrates a signal process circuit for a transmission signal applied to the present disclosure.

FIG. 22 illustrates another example of a wireless device applied to the present disclosure.

FIG. 23 illustrates a hand-held device applied to the present disclosure.

FIG. 24 illustrates a vehicle or an autonomous driving vehicle applied to the present disclosure.

FIG. 25 illustrates a vehicle applied to the present disclosure.

FIG. 26 illustrates an XR device applied to the present disclosure.

FIG. 27 illustrates a robot applied to the present disclosure.

FIG. 28 illustrates an AI device applied to the present disclosure.

### MODE FOR INVENTION

The following technologies may be used in a variety of wireless communication systems, such as code division multiple access (CDMA), frequency division multiple access (FDMA), time division multiple access (TDMA), orthogonal frequency division multiple access (OFDMA), single carrier frequency division multiple access (SC-FDMA), and non-orthogonal multiple access (NOMA). CDMA may be implemented using a radio technology, such as universal terrestrial radio access (UTRA) or CDMA2000. TDMA may be implemented using a radio technology, such as global system for mobile communications (GSM)/general packet radio service (GPRS)/enhanced data rates for GSM evolution (EDGE). OFDMA may be implemented using a radio technology, such as Institute of electrical and electronics engineers (IEEE) 802.11 (Wi-Fi), IEEE 802.16 (WiMAX), IEEE 802.20, or evolved UTRA (E-UTRA). UTRA is part of a universal mobile telecommunications system (UMTS). 3rd generation partnership project (3GPP) Long term evolution (LTE) is part of an evolved UMTS (E-UMTS) using evolved UMTS terrestrial radio access (E-UTRA), and it adopts OFDMA in downlink and adopts SC-FDMA in uplink. LTE-advanced (LTE-A) is the evolution of 3GPP LTE.

For clarity, the description is based on a 3GPP communication system (eg, LTE, NR, etc.), but the technical idea of the present invention is not limited thereto. LTE refers to the technology after 3GPP TS 36.xxx Release 8. In detail, LTE technology after 3GPP TS 36.xxx Release 10 is referred to as LTE-A, and LTE technology after 3GPP TS 36.xxx Release 13 is referred to as LTE-A pro. 3GPP NR refers to the technology after TS 38.xxx Release 15. 3GPP 6G may mean technology after TS Release 17 and/or Release 18. “xxx” means standard document detail number. LTE/NR/6G may be collectively referred to as a 3GPP system. Background art, terms, abbreviations, and the like used in the description of the present invention may refer to matters described in standard documents published before the present invention. For example, you can refer to the following document:\

### 3GPP LTE

36.211: Physical channels and modulation
36.212: Multiplexing and channel coding
36.213: Physical layer procedures
36.300: Overall description
36.331: Radio Resource Control (RRC)

### 3GPP NR

38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

### Physical Channel and Frame Structure

### Physical Channels and General Signal Transmission

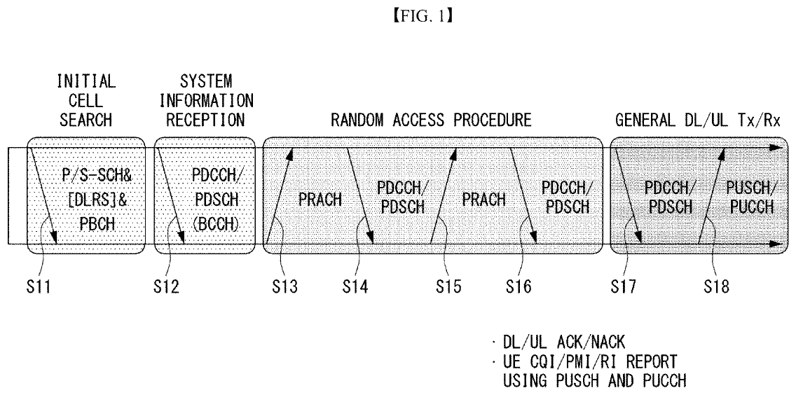

FIG. 1 illustrates physical channels and general signal transmission used in a 3GPP system. In a wireless communication system, a terminal receives information from a base station through a downlink (DL), and the terminal transmits information to the base station through an uplink (UL). The information transmitted and received by the base station and the terminal includes data and various control information, and various physical channels exist according to the type/use of information transmitted and received by them.

When the terminal is powered on or newly enters a cell, the terminal performs an initial cell search operation such as synchronizing with the base station (S101). To this end, the UE receives a Primary Synchronization Signal (PSS) and a Secondary Synchronization Signal (SSS) from the base station to synchronize with the base station and obtain information such as cell ID. Thereafter, the terminal may receive a physical broadcast channel (PBCH) from the base station to obtain intra-cell broadcast information. Meanwhile, the UE may receive a downlink reference signal (DL RS) in the initial cell search step to check a downlink channel state.

After completing the initial cell search, the UE receives a physical downlink control channel (PDCCH) and a physical downlink shared channel (PDSCH) according to the information carried on the PDCCH, thereby receiving a more specific system Information can be obtained (S102).

On the other hand, when accessing the base station for the first time or when there is no radio resource for signal transmission, the terminal may perform a random access procedure (RACH) for the base station (S103 to S106). To this end, the UE transmits a specific sequence as a preamble through a physical random access channel (PRACH) (S103 and S105), and a response message to the preamble through a PDCCH and a corresponding PDSCH (RAR (Random Access Response) message) In the case of contention-based RACH, a contention resolution procedure may be additionally performed (S106).

After performing the above-described procedure, the UE receives PDCCH/PDSCH (S107) and physical uplink shared channel (PUSCH)/physical uplink control channel as a general uplink/downlink signal transmission procedure. (Physical Uplink Control Channel; PUCCH) transmission (S108) can be performed. In particular, the terminal may receive downlink control information (DCI) through the PDCCH. Here, the DCI includes control information such as resource allocation information for the terminal, and different formats may be applied according to the purpose of use.

On the other hand, control information transmitted by the terminal to the base station through uplink or received by the terminal from the base station is a downlink/uplink ACK/NACK signal, a channel quality indicator (CQI), a precoding matrix index (PMI), and (Rank Indicator) may be included. The terminal may transmit control information such as CQI/PMI/RI described above through PUSCH and/or PUCCH.

### Structure of Uplink and Downlink Channels

### Downlink Channel Structure

The base station transmits a related signal to the terminal through a downlink channel to be described later, and the terminal receives a related signal from the base station through a downlink channel to be described later.

### (1) Physical Downlink Shared Channel (PDSCH)

PDSCH carries downlink data (eg, DL-shared channel transport block, DL-SCH TB), and includes Quadrature Phase Shift Keying (QPSK), Quadrature Amplitude Modulation (QAM), 64 QAM, 256 QAM, etc. The modulation method is applied. A codeword is generated by encoding TB. The PDSCH can carry multiple codewords. Scrambling and modulation mapping are performed for each codeword, and modulation symbols generated from each codeword are mapped to one or more layers (Layer mapping). Each layer is mapped to a resource together with a demodulation reference signal (DMRS) to generate an OFDM symbol signal, and is transmitted through a corresponding antenna port.

### (2) Physical Downlink Control Channel (PDCCH)

The PDCCH carries downlink control information (DCI) and a QPSK modulation method is applied. One PDCCH is composed of 1, 2, 4, 8, 16 Control Channel Elements (CCEs) according to the Aggregation Level (AL). One CCE consists of 6 REGs (Resource Element Group). One REG is defined by one OFDM symbol and one (P)RB.

The UE acquires DCI transmitted through the PDCCH by performing decoding (aka, blind decoding) on the set of PDCCH candidates. The set of PDCCH candidates decoded by the UE is defined as a PDCCH search space set. The search space set may be a common search space or a UE-specific search space. The UE may acquire DCI by monitoring PDCCH candidates in one or more search space sets set by MIB or higher layer signaling.

### Uplink Channel Structure

The terminal transmits a related signal to the base station through an uplink channel to be described later, and the base station receives a related signal from the terminal through an uplink channel to be described later.

### (1) Physical Uplink Shared Channel (PUSCH)

PUSCH carries uplink data (eg, UL-shared channel transport block, UL-SCH TB) and/or uplink control information (UCI), and CP-OFDM (Cyclic Prefix-Orthogonal Frequency Division Multiplexing) waveform (waveform), DFT-s-OFDM (Discrete Fourier Transform-spread-Orthogonal Frequency Division Multiplexing) is transmitted based on the waveform. When the PUSCH is transmitted based on the DFT-s-OFDM waveform, the UE transmits the PUSCH by applying transform precoding. For example, when transform precoding is not possible (eg, transform precoding is disabled), the UE transmits a PUSCH based on the CP-OFDM waveform, and when transform precoding is possible (eg, transform precoding is enabled), the UE is CP-OFDM. PUSCH may be transmitted based on a waveform or a DFT-s-OFDM waveform. PUSCH transmission is dynamically scheduled by the UL grant in the DCI or is semi-static based on higher layer (e.g., RRC) signaling (and/or Layer 1 (L1) signaling (e.g., PDCCH)). Can be scheduled (configured grant). PUSCH transmission may be performed based on a codebook or a non-codebook.

### (2) Physical Uplink Control Channel (PUCCH)

The PUCCH carries uplink control information, HARQ-ACK, and/or scheduling request (SR), and may be divided into a plurality of PUCCHs according to the PUCCH transmission length.

### 6G System General

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | |
|---|---|
| Per device peak data rate | 1 Tbps |
| E2E latency | 1 ms |
| Maximum spectral efficiency | 100 bps/Hz |
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

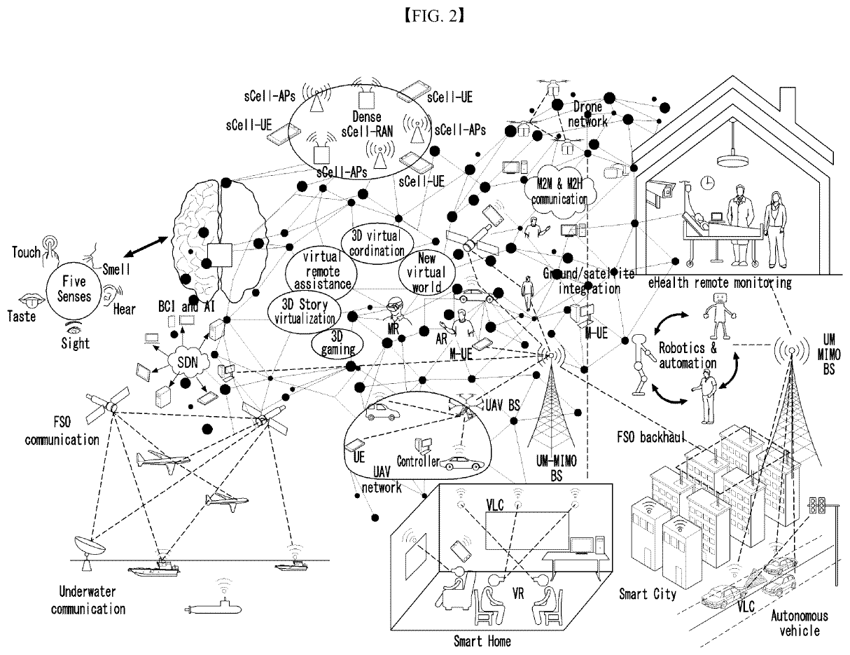

FIG. 2 is a view showing an example of a communication structure providable in a 6G system applicable to the present disclosure.

The 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.

Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimemtion connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduce costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### Core Implementation Technology of 6G System

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging.

AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

Machine learning refers to a series of operations to train a machine in order to create a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

An artificial neural network is an example of connecting several perceptrons.

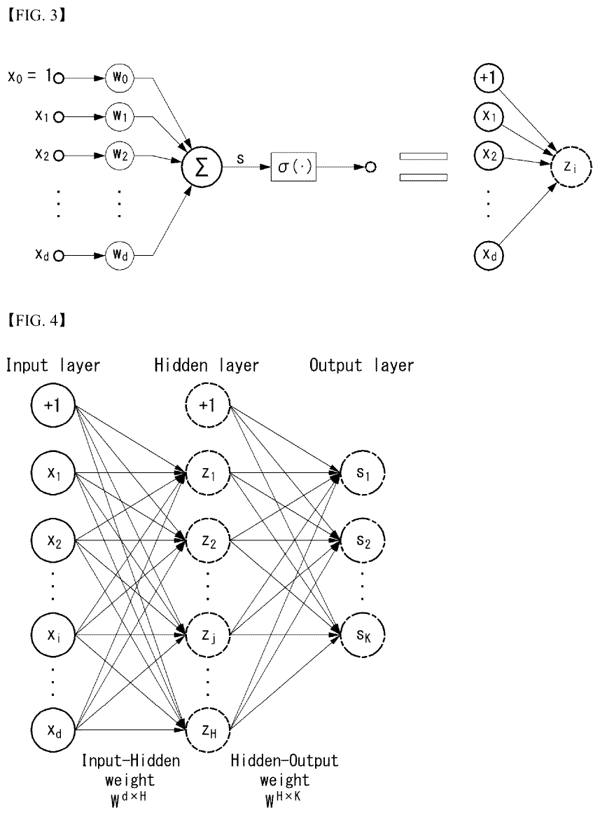

Referring to FIG. 3, when an input vector x=(x1, x2, . . . , xd) is input, each component is multiplied by a weight (W1, W2, . . . , Wd), and all the results are summed. After that, the entire process of applying the activation function σ(·) is called a perceptron. The huge artificial neural network structure may extend the simplified perceptron structure shown in FIG. 3 to apply input vectors to different multidimensional perceptrons. For convenience of explanation, an input value or an output value is referred to as a node.

Meanwhile, the perceptron structure illustrated in FIG. 3 may be described as being composed of a total of three layers based on an input value and an output value. An artificial neural network in which H (d+1) dimensional perceptrons exist between the 1st layer and the 2nd layer, and K (H+1) dimensional perceptrons exist between the 2nd layer and the 3rd layer, as shown in FIG. 4.

The layer where the input vector is located is called an input layer, the layer where the final output value is located is called the output layer, and all layers located between the input layer and the output layer are called a hidden layer. In the example of FIG. 4, three layers are disclosed, but since the number of layers of the artificial neural network is counted excluding the input layer, it can be viewed as a total of two layers. The artificial neural network is constructed by connecting the perceptrons of the basic blocks in two dimensions.

The above-described input layer, hidden layer, and output layer can be jointly applied in various artificial neural network structures such as CNN and RNN to be described later as well as multilayer perceptrons. The greater the number of hidden layers, the deeper the artificial neural network is, and the machine learning paradigm that uses the deep enough artificial neural network as a learning model is called Deep Learning. In addition, the artificial neural network used for deep learning is called a deep neural network (DNN).

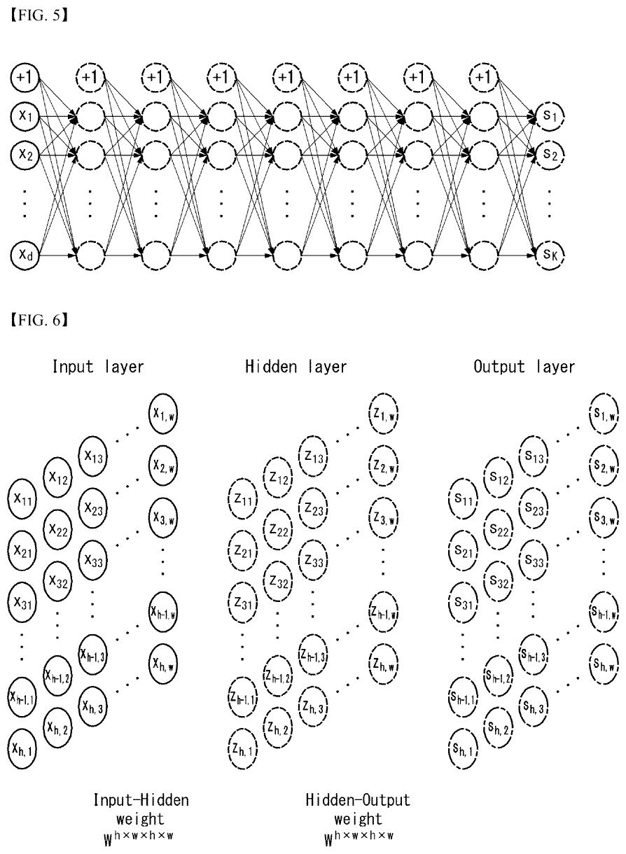

The deep neural network shown in FIG. 5 is a multilayer perceptron composed of eight hidden layers+output layers. The multilayer perceptron structure is expressed as a fully-connected neural network. In a fully connected neural network, a connection relationship does not exist between nodes located on the same layer, and a connection relationship exists only between nodes located on adjacent layers. DNN has a fully connected neural network structure and is composed of a combination of multiple hidden layers and activation functions, so it can be usefully applied to understand the correlation characteristics between input and output. Here, the correlation characteristic may mean a joint probability of input/output. FIG. 5 illustrates example of a structure of a deep neural network.

‘On the other hand, depending on how the plurality of perceptrons are connected to each other, various artificial neural network structures different from the aforementioned DNN can be formed.

In a DNN, nodes located inside one layer are arranged in a one-dimensional vertical direction. However, in FIG. 6, it may be assumed that w nodes are arranged in two dimensions, and h nodes are arranged in a two-dimensional manner (convolutional neural network structure of FIG. 6). In this case, since a weight is added per connection in the connection process from one input node to the hidden layer, a total of h×w weights must be considered. Since there are h×w nodes in the input layer, a total of h2w2 weights are required between two adjacent layers.

FIG. 6 illustrates example of a structure of a convolutional neural network

The convolutional neural network of FIG. 6 has a problem in that the number of weights increases exponentially according to the number of connections, so instead of considering the connection of all modes between adjacent layers, it is assumed that a filter having a small size exists. Thus, as shown in FIG. 7, weighted sum and activation function calculations are performed on a portion where the filters overlap.

One filter has a weight corresponding to the number as much as the size, and learning of the weight may be performed so that a certain feature on an image can be extracted and output as a factor. In FIG. 7, a filter having a size of 3×3 is applied to the upper leftmost 3×3 area of the input layer, and an output value obtained by performing a weighted sum and activation function operation for a corresponding node is stored in z22.

While scanning the input layer, the filter performs weighted summation and activation function calculation while moving horizontally and vertically by a predetermined interval, and places the output value at the position of the current filter. This method of operation is similar to the convolution operation on images in the field of computer vision, so a deep neural network with this structure is called a convolutional neural network (CNN), and a hidden layer generated as a result of the convolution operation. Is referred to as a convolutional layer. In addition, a neural network in which a plurality of convolutional layers exists is referred to as a deep convolutional neural network (DCNN).

FIG. 7 illustrates an example of a filter operation in a convolutional neural network.

In the convolutional layer, the number of weights may be reduced by calculating a weighted sum by including only nodes located in a region covered by the filter in the node where the current filter is located. Due to this, one filter can be used to focus on features for the local area. Accordingly, the CNN can be effectively applied to image data processing in which the physical distance in the 2D area is an important criterion. Meanwhile, in the CNN, a plurality of filters may be applied immediately before the convolution layer, and a plurality of output results may be generated through a convolution operation of each filter.

Meanwhile, there may be data whose sequence characteristics are important according to data properties. Considering the length variability of the sequence data and the relationship between the sequence data, one element in the data sequence is input at each timestep, and the output vector (hidden vector) of the hidden layer output at a specific time point is input together with the next element in the sequence. The structure applied to the artificial neural network is called a recurrent neural network structure.

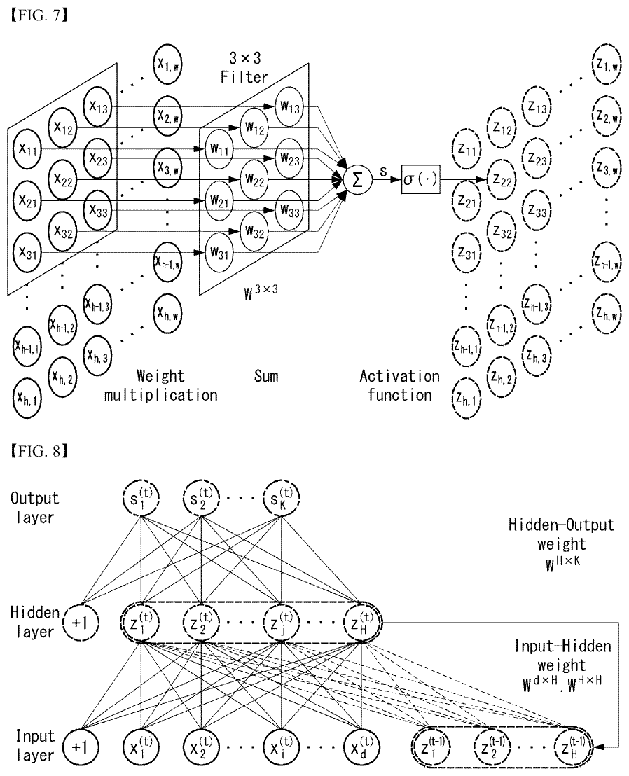

Referring to FIG. 8, a recurrent neural network (RNN) is a fully connected neural network with elements (x1(t), x2(t), . . . , xd(t)) of any line of sight t on a data sequence. In the process of inputting, the point t−1 immediately preceding is the weighted sum and activation function by inputting the hidden vectors (z1(t−1), z2(t−1), . . . , zH(t−1)) together. It is a structure to be applied. The reason for transferring the hidden vector to the next view in this way is that information in the input vector at the previous views is regarded as accumulated in the hidden vector of the current view.

FIG. 8 illustrates an example of a neural network structure in which a circular loop.

Referring to FIG. 8, the recurrent neural network operates in a predetermined order of time with respect to an input data sequence.

Hidden vectors (z1(1), z2(1), . . . , zH(1)) is input with the input vector (x1(2), x2(2), . . . , xd(2)) of the time point 2, and the vector (z1(2), z2(2), . . . , zH(2)) is determined. This process is repeatedly performed up to the time point 2, time point 3, . . . , time point T.

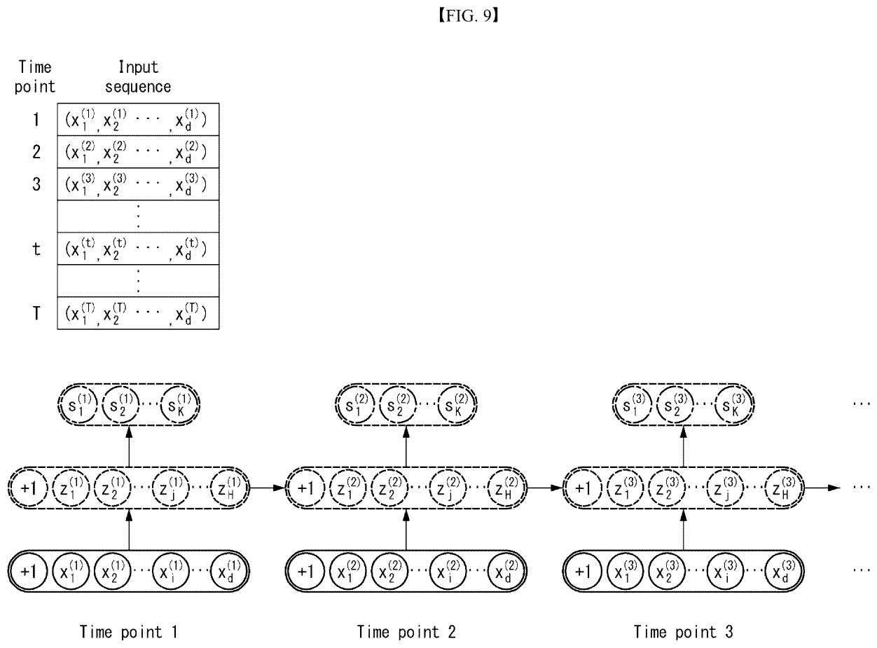

FIG. 9 illustrates an example of an operation structure of a recurrent neural network.

Meanwhile, when a plurality of hidden layers are disposed in a recurrent neural network, this is referred to as a deep recurrent neural network (DRNN). The recurrent neural network is designed to be usefully applied to sequence data (for example, natural language processing).

As a neural network core used as a learning method, in addition to DNN, CNN, and RNN, Restricted Boltzmann Machine (RBM), deep belief networks (DBN), and deep Q-networks Network), and can be applied to fields such as computer vision, speech recognition, natural language processing, and voice/signal processing.

### Auto Encoder

Various attempts are being made to apply neural networks to communication systems. In particular, among various attempts to apply neural networks to communication systems, attempts to apply neural networks to the physical layer mainly focused on optimizing specific functions of the receiver. For example, the performance improvement of the receiver can be achieved by configuring the channel decoder as a neural network. As another example, in a MIMO system with multiple transmit/receive antennas, the performance improvement can be achieved by implementing a MIMO detector as a neural network.

Another approach to apply a neural network to a communication system is to use an auto encoder in the communication system. Here, the auto encoder is a type of artificial neural network that has the characteristic of outputting the same information as the information input to the auto encoder. Since the goal of a communication system is to ensure that the signal transmitted from the transmitter is restored at the receiver without distortion, the characteristics of the auto encoder can suit the goal of the communication system.

When applying the auto encoder to the communication system, the transmitter and receiver of the communication system each are configured as a neural network, which allows performance improvements to be achieved by performing optimization from an end-to-end perspective.

An auto encoder to optimize end-to-end performance operates by configuring both the transmitter and receiver as a neural network.

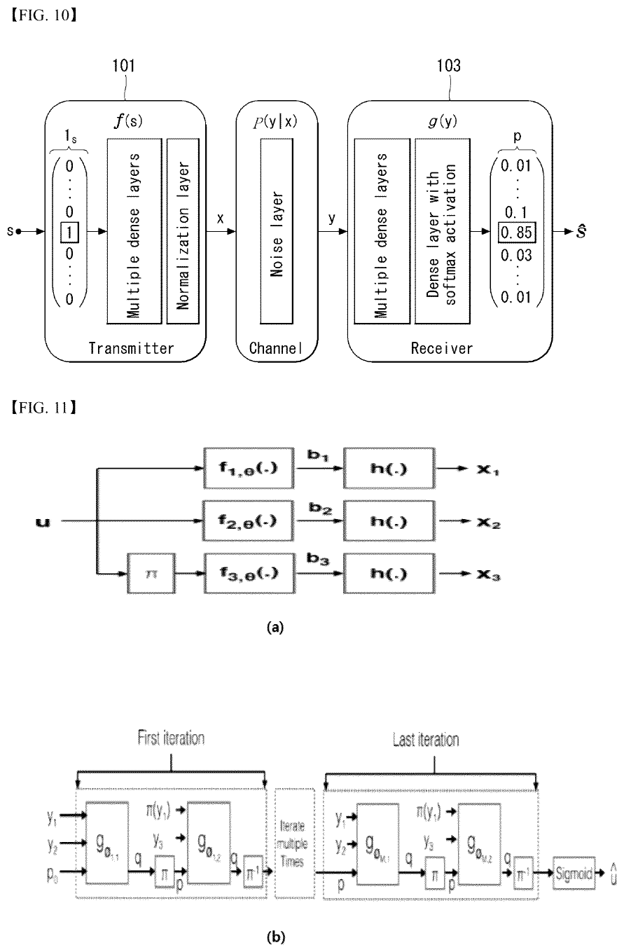

FIGS. 10 and 11 illustrate an example of an auto encoder configured based on a transmitter and a receiver configured as a neural network.

First, in FIG. 10, a transmitter 1010 is configured as a neural network expressed as f(s), and a receiver 1030 is configured as a neural network expressed as g(y). That is, the neural networks (f(s) and g(v)) are components of the transmitter 1010 and the receiver 1030, respectively. In other words, the transmitter 1010 and the receiver 1030 are each configured as a neural network (or based on a neural network).

Based on the structural perspective of the auto encoder, the transmitter 1010 can be interpreted as an encoder f(s), which is one of the components configuring the auto encoder, and the receiver 1030 can be interpreted as a decoder g(v), which is one of the components configuring the auto encoder. In addition, a channel exists between the transmitter 1010, which is the encoder f(s) configuring the auto encoder, and the receiver 1030, which is the decoder g(v) configuring the auto encoder. Here, the neural network configuring the transmitter 1010 and the neural network configuring the receiver 1030 can be trained to optimize end-to-end performance for the channel. According to the above interpretation, hereinafter, the transmitter 1010 can be called a ‘transmitter encoder’, the receiver 1030 can be called a ‘receiver decoder’, and it can be called in various ways within the scope of being interpreted identically/similarly to this. In addition, hereinafter, the neural network configuring the transmitter 1010 can be called a transmitter encoder neural network, the neural network configuring the receiver 1030 can be called a receiver decoder neural network, and it can be called in various ways within the scope of being interpreted identically/similarly to this. However, when data transmission is performed based on a neural network configured as shown in FIG. 10, depending on the size of the input data block, a problem may occur in which the size of the training data for training the neural network increases exponentially.

Next, in FIG. 11, FIG. 11(a) illustrates an example of a transmitter encoder neural network configuration, and FIG. 11(b) illustrates an example of a receiver decoder neural network configuration.

In FIG. 11(a), the input data block u is encoded based on the transmitter encoder neural network and output as values of x1, x2, and x3. The output data x1, x2, and x3 encoded by the transmitter encoder neural network pass through the channel between the transmitter and the receiver, are received by the receiver, and are then decoded. However, when configuring the transmitter encoder neural network and the receiver decoder neural network as shown in FIG. 11, since the auto encoder is configured based on a neural network configured as multiple layers (especially, in the receiver decoder neural network), problems may arise that increase the complexity of the auto encoder configuration.

In addition, in addition to the neural network structure described in FIGS. 10 and 11, when the neural network configuring the transmitter and the neural network configuring the receiver are configured in the form of a fully-connected neural network, the complexity of the auto encoder configuration increases. Therefore, in order to reduce the complexity of the auto encoder configuration, a simple neural network structure needs to be applied to the auto encoder configuration.

When polar code, one of the error correction codes used in the 5G communication system, is used, encoding of data is performed in a structured manner. In addition, the polar coat is known as a coding scheme that can reach channel capacity through a polarization effect. However, the case where the channel capacity can be reached through the polarization effect corresponds to the case where the input block size becomes infinitely large, so when the input block size is finite, the channel capacity cannot be achieved. Therefore, a neural network structure that can reduce complexity while improving performance needs to be applied to the auto encoder configuration.

The present disclosure proposes a method of configuring a neural network at the transmitter and a neural network at the receiver based on a sparsely-connected neural network structure to reduce the complexity of auto encoder configuration.

Additionally, the present disclosure proposes a decoding method based on a plurality of basic receiver modules that process small input data blocks to ensure convergence during training of the transmitter and receiver configured as a neural network. Additionally, the present disclosure proposes a decoding algorithm used at the receiver. More specifically, the decoding algorithm relates to a method of applying a list decoding method to a neural network.

It has the effect of reducing the complexity of auto encoder configuration by the above methods proposed in the present disclosure. Additionally, it has the effect of improving the performance of the auto encoder by applying the list decoding method to a neural network.

### Method of Configuring Neural Network of Transmitter Encoder/Receiver Decoder

A method of configuring an auto encoder-based transmitter encoder neural network and receiver decoder neural network proposed in the present disclosure is to apply the Polar code method, one of the error correction codes, to artificial intelligence.

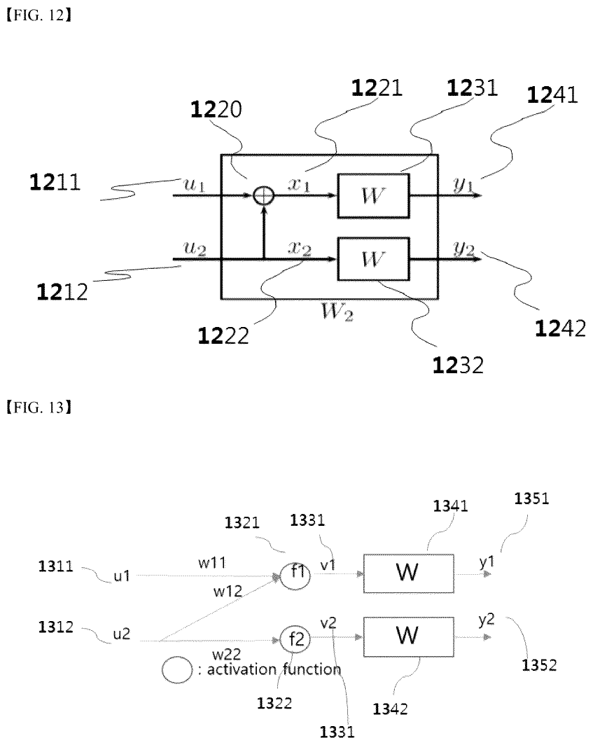

Before a detailed explanation of the application of the polar code method to artificial intelligence, let us first look at the polar code with reference to FIG. 12.

FIG. 12 is a diagram illustrating an example of a polar code to help understand a method proposed in the present disclosure.

More specifically, FIG. 12 illustrates an example of a basic encoding unit configuring a polar code. The polar code can be configured by using multiple basic encoding units shown in FIG. 12.

In FIG. 12, u1 and u2 (1211 and 1212) represent input data input into the basic encoding unit configuring the polar code, respectively. ⊕ operation 1220 is applied to the input data u1 and u2 (1211 and 1212) to generate x1 (1221), and the x1 (1221) passes through channel W (1231) to output output data y1 (1241). In addition, x2 (1222), which is data for which no separate operation is applied to the input data u2 (1212), passes through the channel W (1232) to output output data y2 (1242). In FIG. 12, the channels W (1231 and 1232) may be binary memory less channels. At this time, the transition probability of the basic encoding unit configuring the polar code can be defined as Equation 1 below.

$${W}_{2} ( {y}_{1} , {y}_{2} ; {u}_{1} , {u}_{2} ) = W ( {y}_{1} \vert {u}_{1} ⊕ {u}_{2} ) W ( {y}_{2} \vert {u}_{2} ) \qquad [ Equation 1 ]$$

Additionally, the transition probability according to channel division can be defined as Equation 2 below.

$${W}_{N}^{( i )} ( {y}_{1}^{N} , {u}_{1}^{i - 1} \vert {u}_{i} ) = {\sum }_{{u}_{i + 1}^{N}} \frac{1}{{2}^{N - 1}} {W}_{N} ( {y}_{1}^{N} \vert {u}_{1}^{N} ) \qquad [ Equation 2 ]$$

The channel division refers to the process of combining N B-DMC channels and then defining equivalent channels for a specific input. In Equation 2, W_{N}⁽ⁱ⁾ represents the equivalent channel of i-th channel among N channels.

Decoding of the polar code can be performed using Successive Cancellation (SC) decoding or SC list decoding. When the size of the input data block is N, recursive SC decoding can be performed based on Equation 3 and Equation 4 below.

$$\text{?} = \text{?} = \text{?} = \text{?} = \text{?} \qquad [ Equation 3 ]$$

$$\text{?} = \text{?} = \text{?} = \text{?} = \text{?} \qquad [ Equation 4 ]$$

$$\text{?} \text{indicates text missing or illegible when filed}$$

### Method of Configuring Transmitter Encoder Neural Network—Proposal 1

The present proposal relates to a method of configuring a transmitter encoder neural network to reduce the complexity of auto encoder configuration.

FIG. 13 is a diagram illustrating an example of a method of configuring a transmitter encoder neural network proposed in the present disclosure.

More specifically, FIG. 13 is a diagram illustrating an example of a basic unit configuring a transmitter encoder neural network. The partially-connected transmitter encoder neural network proposed in the present disclosure can be configured by using at least one basic unit configuring the transmitter encoder neural network shown in FIG. 13. Hereinafter, the basic unit configuring the transmitter encoder neural network may be expressed as a neural network configuration unit, a neural network basic configuration unit, etc., and may be expressed in various ways within the scope of being interpreted identically/similarly to this.

In FIG. 13, u1 and u2 (1311 and 1312) represent input data input to the neural network configuration unit, respectively. A weight w11 is applied to input data u1 (1311), and a weight w12 is applied to the input data u2 (1312). After the each weighted input data u1 (1311) and the input data u2 (1312) are combined, an activation function f1 (1321) is applied to become v1 (1331). Here, the weight w11 is applied to the path through which input data u1 (1311) is input to the activation function f1 (1321), and the weight w12 is applied to the path through which the input data u2 (1312) is input to the activation function f1 (1321). Afterwards, the v1 (1331) passes through channel W (1341) and output data y1 (1351) is output.

Additionally, in FIG. 13, weight w22 is applied to the input data u2 (1312), and an activation function f2 (1322) is applied to become v2 (1332). Here, the weight w22 is applied to the path through which the input data u2 (1312) is input to the activation function f2 (1322). Afterwards, the v2 (1332) passes through channel W (1342) and output data y1 (1352) is output. In FIG. 13, the channels W (1341 and 1342) may be binary memory less channels. A process in which the input data u1 and u2 (1311 and 1312) are input to the neural network configuration unit and the y1 and y2 (1351 and 1352) are output can be understood as a process in which the input data u1 and u2 (1311 and 1312) are encoded. The transmitter encoder neural network can be pre-trained for optimized data transmission and reception, and through training, values of the weights of the neural network configuration units configuring the transmitter encoder neural network can be determined.

In FIG. 13, the same function may be used as the activation function f1 (1321) and the activation function f2 (1322). Additionally, different functions may be used as the activation function f1 (1321) and the activation function f2 (1322). When different functions are used for the activation function f1 (1321) and the activation function f2 (1322), the f2 (1322) may be a function that satisfies Equation 5 below.

$${f}_{2} ( x ) = x \qquad [ Equation 5 ]$$

When the f2 (1322) is configured as in Equation 5 above, the neural network configuration unit may have characteristics similar to those of the polar code described in FIG. 12.

Additionally, the range of values that an output value of each of the activation function f1 (1321) and the activation function f2 (1322) can have may be limited to a specific number of quantized values. Instead of quantizing the output values of each of the activation function f1 (1321) and the activation function f2 (1322), discrete activation functions may be used for the activation function f1 (1321) and the activation function f2 (1322). By using the discrete activation function, the range of values that the output value of each of the activation function f1 (1321) and the activation function f2 (1322) can have may be limited to a specific number of values.

To summarize what has been described above, the transmitter encoder neural network can be described as being configured based on a neural network configuration unit that receives two input values and outputs two output values. Additionally, the neural network configuration unit can be described as being configured as a first activation function that receives both of the two input values and a second activation function that receives only one of the two input values. At this time, it may be described that one of the two output values is output by multiplying the two input values by a weight applied to each of two paths through which the two input values are input into the first activation function, respectively and, applying the first activation function to sum of the two input values each multiplied by the weight. In addition, it may be described that the other one of the two output values is output by multiplying the one input value by a weight applied to a path through which the one input value is input into the second activation function and, and applying the second activation function to one input value multiplied by the weight.

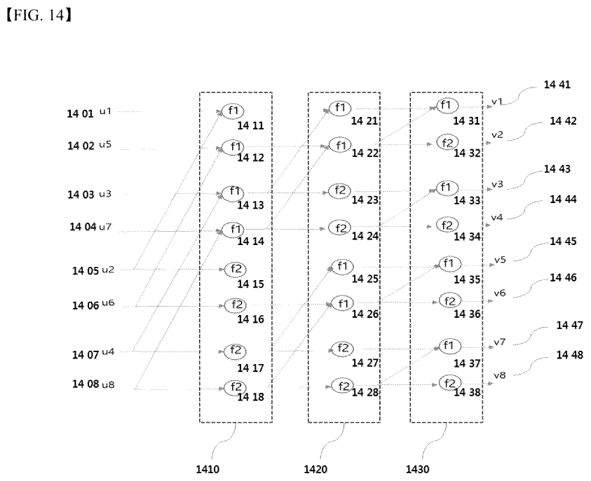

FIG. 14 is a diagram illustrating another example of a method of configuring a transmitter encoder neural network proposed in the present disclosure.

More specifically, FIG. 14 relates to a method of configuring a transmitter encoder neural network that can be applied when the size of the input data block input to the transmitter encoder neural network is 8.

In FIG. 14, when the size of the input data block is 8, the transmitter encoder neural network is configured as three layers, and each layer is configured based on four neural network configuration units. That is, the transmitter encoder neural network is configured as a first layer 1410, a second layer 1420, and a third layer 1430, and the first to third layers 1410 to 1430 each include four neural network configuration units.

First, looking at the first layer 1410, the first layer is configured with (i) a 1-1 neural network configuration unit configured with the activation function f1 (1411) and the activation function f2 (1415), (ii) a 1-2 neural network configuration unit configured with the activation function f1 (1412) and the activation function f2 (1416), (iii) a 1-3 neural network configuration unit configured with the activation function f1 (1413) and the activation function f2 (1417), and (iv) a 1-4 neural network configuration unit configured with the activation function f1 (1414) and the activation function f2 (1418).

The activation function f1 (1411) of the 1-1 neural network configuration unit receives input data u1 and u2 (1401 and 1405) and applies the activation function to output them, and the activation function f2 (1415) of the 1-1 neural network configuration unit receives input data u2 (1405) and applies an activation function to output the input data. Next, the activation function f1 (1412) of the 1-2 neural network configuration unit receives input data u5 and u6 (1402 and 1406) and applies the activation function to output them, and the activation function f2 (1416) of the 1-2 neural network configuration unit receives input data u6 (1406) and applies an activation function to outputs it. Additionally, the activation function f1 (1413) of the 1-3 neural network configuration unit receives input data u3 and u4 (1403 and 1407) and applies an activation function to output them, and the activation function f2 (1417) of the 1-3 neural network configuration unit receives input data u4 (1407) and applies the activation function to outputs it. Finally, the activation function f1 (1414) of the 1-4 neural network configuration unit receives input data u7 and u8 (1404 and 1408) and applies the activation function to outputs them, and the activation function f2 (1418) of the 1-4 neural network configuration unit receives input data u8 (1408) and applies the activation function to output it. Although not shown in FIG. 14, when the activation functions included in the first layer 1410 receive input data, it can be understood that the input data is multiplied by a weight and input to the activation functions, and it can be equally understood in the second layer 1420 and the third layer 1430 described below.

Looking at the form in which the activation functions configuring the first layer 1410 receive input data u1 to u8 (1401 to 1408), it can be seen that one input data is not input to all activation functions included in the first layer 1410, but only to some of all activation functions included in the first layer 1410. In other words, it can be described that the activation functions included in the first layer 1410 receive only some input values of all input values that can be input to each of the activation functions.

Next, looking at the second layer 1420, the second layer is configured with (i) a 2-1 neural network configuration unit configured with the activation function f1 (1421) and the activation function f2 (1423), (ii) a 2-2 neural network configuration unit configured with the activation function f1 (1422) and the activation function f2 (1424), (iii) 2-3 neural network configuration unit configured with the activation function f1 (1425) and the activation function f2 (1427), and (iv) 2-4 neural network configuration unit configured with the activation function f1 (1426) and the activation function f2 (1428).

The activation function f1 (1421) of the 2-1 neural network configuration unit receives (i) the output value of the activation function f1 (1411) of the 1-1 neural network configuration unit and (ii) the output value of activation function f1 (1413) of the 1-3 neural network configuration unit and applies the activation function to outputs them, and the activation function f2 (1423) of the 2-1 neural network configuration unit receives the output value of the activation function f1 (1413) of the 1-3 neural network configuration unit and applies the activation function to outputs it. In addition, the activation function f1 (1422) of the 2-2 neural network configuration unit receives (i) the output value of the activation function f1 (1412) of the 1-2 neural network configuration unit, and (ii) the output value of the activation function f1 (1414) of the 1-4 neural network configuration unit and applies the activation function to output them, and the activation function f2 (1424) of the 2-2 neural network configuration unit receives the output value of activation function f1 (1414) of the 1-4 neural network configuration unit and applies the activation function to outputs it. Next, the activation function f1 (1425) of the 2-3 neural network configuration unit receives (i) the output value of the activation function f2 (1415) of the 1-1 neural network configuration unit and (ii) the output value of the activation function f2 (1417) of the 1-3 neural network configuration unit and applies the activation function to output them, and the activation function f2 (1427) of the 2-3 neural network configuration unit receives the output value of the activation function f2 (1417) of the 1-3 neural network configuration unit and applies the activation function to output it. Finally, the activation function f1 (1426) of the 2-4 neural network configuration unit receives (i) the output value of the activation function f2 (1416) of the 1-2 neural network configuration unit, and (ii) the output value of the activation function f2 (1418) of the 1-4 neural network configuration unit and applies the activation function to output them, and the activation function f2 (1428) of the 2-4 neural network configuration unit receives the output value of the activation function f2 (1418) of the 1-4 neural network configuration unit and applies the activation function to output it.

Looking at the form in which the activation functions configuring the second layer 1420 receive data from the first layer 1410, it can be seen that one input data is not input to all activation functions included in the second layer 1420, but only to some of all activation functions included in the second layer 1420. In other words, it can be described that the activation functions included in the second layer 1420 receive only some input values of all input values that can be input to each of the activation functions.

Finally, looking at the third layer (1430), the third layer is configured with (i) a 3-1 neural network configuration unit configured with the activation function f1 (1431) and the activation function f2 (1432), (ii) a 3-2 neural network configuration unit configured with the activation function f1 (1433) and the activation function f2 (1434), (iii) 3-3 neural network configuration unit configured with the activation function f1 (1435) and the activation function f2 (1436), and (iv) 3-4 neural network configuration unit configured with the activation function f1 (1437) and the activation function f2 (1438).

The activation function f1 (1431) of the 3-1 neural network configuration unit receives (i) the output value of the activation function f1 (1421) of the 2-1 neural network configuration unit and (ii) the output value of activation function f1 (1422) of the 2-2 neural network configuration unit and applies the activation function to output v1 (1441), and the activation function f2 (1432) of the 3-1 neural network configuration unit receives the output value of the activation function f1 (1422) of the 2-2 neural network configuration unit and applies the activation function to output v2 (1442). Next, the activation function f1 (1433) of the 3-2 neural network configuration unit receives (i) the output value of the activation function f2 (1423) of the 2-1 neural network configuration unit, and (ii) the output value of the activation function f2 (1424) of the 2-2 neural network configuration unit and applies the activation function to output v3 (1443), and the activation function f2 (1434) of the 3-2 neural network configuration unit receives the output value of activation function f2 (1424) of the 2-2 neural network configuration unit and applies the activation function to output v4 (1444). In addition, the activation function f1 (1435) of the 3-3 neural network configuration unit receives (i) the output value of the activation function f1 (1425) of the 2-3 neural network configuration unit and (ii) the output value of the activation function f1 (1426) of the 2-4 neural network configuration unit and applies the activation function to output v5 (1445), and the activation function f2 (1436) of the 3-3 neural network configuration unit receives the output value of the activation function f1 (1426) of the 2-4 neural network configuration unit and applies the activation function to outputs v6 (1446). Finally, the activation function f1 (1437) of the 3-4 neural network configuration unit receives (i) the output value of the activation function f2 (1427) of the 2-3 neural network configuration unit, and (ii) the output value of the activation function f2 (1428) of the 1-4 neural network configuration unit and applies the activation function to output v7 (1447), and the activation function f2 (1438) of the 3-4 neural network configuration unit receives the output value of the activation function f2 (1428) of the 2-4 neural network configuration unit and applies the activation function to output v8 (1448).

Looking at the form in which the activation functions configuring the third layer 1430 receive data from the second layer 1420, it can be seen that one input data is not input to all activation functions included in the third layer 1430, but only to some of all activation functions included in the third layer 1430. In other words, it can be described that the activation functions included in the third layer 1430 receive only some input values of all input values that can be input to each of the activation functions.

A process in which input data u1 to u8 (1401 and 1408) are input to the transmitter encoder neural network and output as v1 to v8 (1441 and 1448) can be understood as a process in which the input data u1 to u8 (1401 and 1408) are encoded.

To summarize the contents described in FIG. 14 above, it can be described that each of the activation functions included in the transmitter encoder neural network receives only some input values of all input values that can be input to each of the activation functions.

In addition, in FIG. 14, for convenience of explanation, the case where the size of the input data block is 8 is described as an example, but the above description can be generalized to the case where the size of the input data block is 2K (K is an integer greater than 1). At this time, the transmitter encoder neural network may be configured as K layers. Additionally, the K layers each may be configured as 2K−1 neural network configuration units. Since the transmitter encoder neural network is configured as K layers configured as 2K−1 neural network configuration units, the total number of the neural network configuration units configuring the transmitter encoder neural network may be K*2k−1.

### Method of Configuring Receiver Decoder Neural Network—Proposal 2

This proposal relates to a method of configuring a receiver decoder neural network to reduce the complexity of auto encoder configuration.

When the size of the data block input to the receiver decoder neural network is N (N is an integer greater than or equal to 1), the receiver decoder neural network can be configured for an input data block of size N/2 based on the receiver decoder neural network configuration unit that performs decoding.

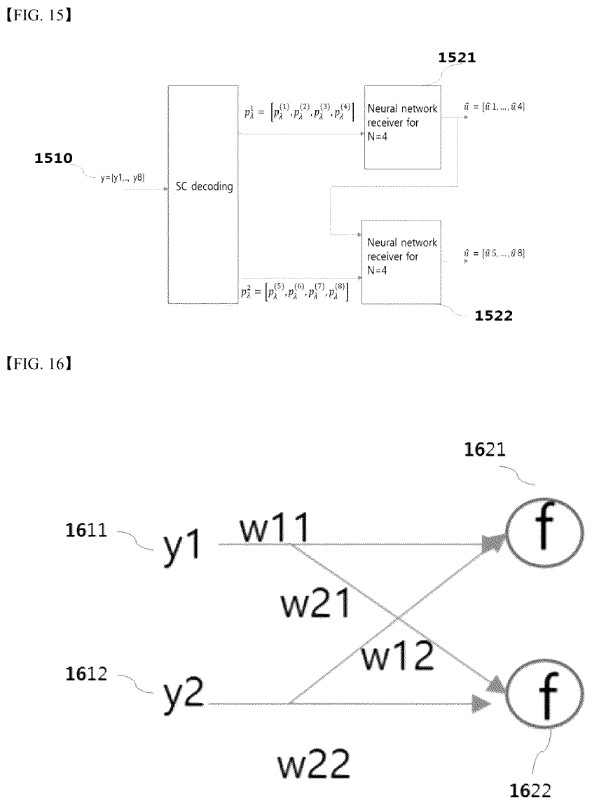

FIG. 15 is a diagram illustrating an example of a method of configuring a receiver decoder neural network proposed in the present disclosure.

More specifically, when the size of the data block input to the receiver decoder neural network is 8, FIG. 15 relates to a method of configuring the receiver decoder neural network based on the receiver decoder neural network configuration unit that performs decoding on an input data block of size 4. In FIG. 15, the receiver decoder neural network is configured as two receiver decoder neural network configuration units (1521 and 1522). The receiver decoder neural network receives input data (1510) of size 8. The input data 1510 may be that input data encoded and transmitted by the transmitter encoder neural network has passed through a channel between the transmitter encoder neural network and the receiver decoder neural network. Here, the receiver decoder neural network configuration unit 1521 performs decoding only on input data blocks of size 4 and restores input data û1 to û4 transmitted from the transmitter encoder neural network. Additionally, the receiver decoder neural network configuration unit 1522 performs decoding only on input data blocks of size 4 and restores input data û5 to û8 transmitted from the transmitter encoder neural network.

When the output value of the activation function configuring the transmitter encoder neural network described in FIGS. 13 and 14 is limited to a certain number (L), the transition probability in the receiver decoder neural network can be defined as Equations 6 and 7 below.

$${p}_{λ}^{( 2 i - 1 )} ( {y}_{1}^{N} , {v}_{1}^{2 i - 1} \vert {v}_{2 i - 1} ) = {\sum }_{{v}_{2 i}} \frac{1}{q} \{ {p}_{λ - 1}^{( i )} ( {y}_{1}^{N / 2} , {f}_{1} ( {v}_{1 , odd}^{2 i - 2} , {v}_{1 , even}^{2 i - 2} ) \vert {f}_{1} ( {v}_{2 i - 1} , {v}_{2 i} ) ) \cdot {p}_{λ - 1}^{( i )} ( {y}_{\frac{N}{2} + 1}^{N} , {v}_{1 , even}^{2 i - 2} \vert {f}_{2} ( {v}_{2 i} ) ) \} \qquad [ Equation 6 ]$$

$${p}_{λ}^{( 2 i )} ( {y}_{1}^{N} , {v}_{1}^{2 i - 1} \vert {v}_{2 i} ) = \frac{1}{q} {p}_{λ - 1}^{( i )} ( {y}_{1}^{N / 2} , {f}_{1} ( {v}_{1 , odd}^{2 i - 2} , {v}_{1 , even}^{2 i - 2} ) \vert {f}_{1} ( {v}_{2 i - 1} , {v}_{2 i} ) ) \cdot {p}_{λ - 1}^{( i )} ( {y}_{\frac{N}{2} + 1}^{N} , {v}_{1 , even}^{2 i - 2} \vert \vert {f}_{2} ( {v}_{2 i} ) ) \qquad [ Equation 7 ]$$

Here, 1≤λ≤r=log₂ N, p₀⁽¹⁾ (y|v)=p(y|v) is satisfied.

Looking at Equations 6 and 7 above, it can be seen that it includes terms f1, f2, etc. related to the activation function configuring the transmitter encoder neural network. Therefore, when the receiver decoder neural network is configured as shown in FIG. 15, information on the weights used for encoding in the transmitter encoder neural network may be required for decoding on data transmitted from the transmitter encoder neural network in the receiver decoder neural network.

By configuring the receiver decoder neural network as shown in FIG. 15, the problem of increasing the size of training data due to an increase in the size of the input data block can be solved. In other words, even if the size of the input data block increases, since the receiver decoder neural network configuration unit can only train about input data blocks whose size is smaller than the size of the input data block, the problem of increasing the size of training data due to an increase in the size of the input data block can be solved.

To summarize the above explanation, the receiver decoder neural network for a data block of size N (N=2n, n is an integer greater than or equal to 1) can be implemented using N/M receiver decoder neural network configuration units of size M=2m (m is an integer greater than or equal to 1). At this time, M can be determined considering training complexity.

Below, three ways to perform list decoding in the receiver decoder neural network will be described.

### (Method 1)

The output bit of the receiver decoder neural network can be obtained by applying a hard decision to the activation function output of the last layer among the layers configuring the receiver decoder neural network. When applying a hard decision to the activation function output of the last layer, because the activation function output of the last layer represents the probability value for the corresponding bit, list decoding can be implemented by managing the decision bit string according to the list size.

For example, if the activation function output for the first bit of the output bit is f(x1), Prob(b1=0 or 1)=f(x1) or 1−f(x1). That is, the probability that the first bit of the output bit is 0 is f(x1), and the probability that the first bit of the output bit is 1 is 1−f(x1). Here, the bit value and the corresponding probability value are stored. If the activation function output for the second bit of the output bit is f(x2), Prob (b2 0 or 1)=f(x2) or 1−f(x2). That is, the probability that the second bit of the output bit is 0 is f(x2), and the probability that the first bit of the output bit is 1 is 1−f(x2). Combining the results with the probability value for the first bit and the probability value for the second bit, Prob (b1b2=00, 01, 10, 11)=f(x1)*f(x2), f(x1)*(1−f(x2)), (1−f(x1))*f(x2), or (1−f(x1))*(1−f(x2)). That is, the probability that b1b2=00 is f(x1)*f(x2), the probability that b1b2=01 is f(x1)*(1−f(x2)), the probability that b1b2=10 is (1−f(x1))*f(x2), and the probability that b1b2=11 is (1−f(x1))*(1−f(x2)). The bit string and the corresponding probability value are stored. In the same way as above, the bit string and the corresponding probability value are stored in the list size. If the number of bit string candidates exceeds the list size, the bit strings corresponding to the list size and their corresponding probability values may be selected and stored in order of increasing probability value.

### (Method 2)

List decoding can be implemented by training a plurality of neural network receivers using different parameters and then combining the trained plurality of neural network receivers. At this time, parameters that can be changed during training may include neural network parameters such as activation function and loss function. Additionally, parameters that can be changed during training may include communication parameters such as SNR and channel model.

### (Method 3)

A plurality of output channels are configured in the receiver decoder neural network, and the receiver decoder neural network can perform a list decoding operation based on the plurality of output channels.

FIG. 16 is a diagram illustrating another example of a method of configuring a receiver decoder neural network proposed in the present disclosure.

More specifically, FIG. 16 is a diagram illustrating an example of a basic unit configuring a receiver decoder neural network. The partially-connected receiver decoder neural network proposed in the present disclosure can be configured by using at least one basic unit configuring the receiver decoder neural network shown in FIG. 16. Hereinafter, the basic unit configuring the receiver decoder neural network may be expressed as a decoder neural network configuration unit, a decoder neural network basic configuration unit, etc., and may be expressed in various ways within the scope that can be interpreted identically/similarly to this.

In FIG. 16, y1 and y2 (1611 and 1612) each represent input data input to the decoder neural network configuration unit. Here, the y1 and y2 (1611 and 1612) may be that input data encoded and transmitted by the transmitter encoder neural network passes through a channel between the transmitter encoder neural network and the receiver decoder neural network and is received from the receiver decoder neural network.

Weight w11 is applied to input data y1 (1611), and weight w12 is applied to input data y2 (1612). The input data y1 (1611) and the input data y2 (1612) to which each weight is applied are combined, and then the activation function f (1621) is applied. Here, the weight w11 is applied to the path through which the input data y1 (1611) is input to the activation function f (1621), and the weight w12 is applied to the path through which the input data y2 (1612) is input to the activation function f1 (1621).

In addition, in FIG. 16, weight w21 is applied to the input data y1 (1611), and the weight w22 is applied to the input data y2 (1612). The input data y1 (1611) and input data y2 (1612) to which each weight is applied are combined, and then the activation function f (1622) is applied. A process in which input data y1 and y2 (1611 and 1612) are input to the decoder neural network configuration unit, weights are applied, and activation functions are applied can be understood as a process in which the input data y1 and v2 (1611 and 1612) are decoded. The receiver decoder neural network can be pre-trained for optimized data transmission and reception, and through training, the values of the weights of the decoder neural network configuration units configuring the receiver decoder neural network can be determined.

In FIG. 16, the same function may be used as the activation function f (1621) and the activation function f (1622). Additionally, different functions may be used as the activation function f (1621) and the activation function f (1622).

FIG. 17 is a diagram illustrating another example of a method of configuring a receiver decoder neural network proposed in the present disclosure.

More specifically, FIG. 17 relates to a method of configuring a receiver encoder neural network that can be applied when the size of the input data block input to the receiver decoder neural network is 8. That is, FIG. 17 relates to a case where a block of input data of size 8 is encoded in a transmitter encoder neural network, and a case where an encoded input data block passes through a channel between a transmitter and a receiver and is received at the receiver.

In FIG. 17, when the size of the data block received from the receiver decoder neural network is 8, the receiver decoder neural network is configured as three layers, and each layer is configured based on four decoder neural network configuration units. That is, the receiver decoder neural network c is configured as a first layer (1710), a second layer (1720), and a third layer (1730), and the first to third layers 1710 to 1730 each include four decoder neural network configuration units.

First, looking at the first layer 1710, the first layer is configured with (i) a 1-1 decoder neural network configuration unit configured with two activation functions f (1711 and 1712), (ii) a 1-2 decoder neural network configuration unit configured with two activation functions f (1713 and 1714), (iii) a 1-3 decoder neural network configuration unit configured with two activation functions f (1715 and 1716), and (iv) a 1-4 decoder neural network configuration unit configured with two activation functions f (1717 and 1718).

Each of the two activation functions (1711 and 1712) of the 1-1 decoder neural network configuration unit receives input data y1 and y2 (1701 and 1702) and applies the activation function to output them. Next, each of the two activation functions (1713 and 1714) of the 1-2 decoder neural network configuration unit receives input data y3 and y4 (1703 and 1704) and applies the activation function to output them. Additionally, each of the two activation functions (1715 and 1716) of the 1-3 decoder neural network configuration unit receives input data y5 and y6 (1705 and 1706) and applies the activation function to output them. Finally, each of the two activation functions (1717 and 1718) of the 1-4 decoder neural network configuration unit receives input data y7 and y8 (1707 and 1708) and applies the activation function to output them. Although not shown in FIG. 17, when the activation functions included in the first layer 1710 receive input data, it can be understood that the input data is multiplied by a weight and input to the activation functions, and it can be equally understood in the second layer 1720 and the third layer 1730 described below.

Looking at the form in which the activation functions configuring the first layer 1710 receive input data y1 to y8 (1701 to 1708), it can be seen that one input data is not input to all activation functions included in the first layer 1710, but only to some of all activation functions included in the first layer 1710. In other words, it can be described that the activation functions included in the first layer 1710 receive only some input values of all input values that can be input to each of the activation functions.

Next, looking at the second layer (1720), the second layer is configured with (i) a 2-1 decoder neural network configuration unit configured with two activation functions f (1721 and 1723), (ii) a 2-2 decoder neural network configuration unit configured with two activation functions f (1722 and 1724), (iii) a 2-3 decoder neural network configuration unit configured with two activation functions f (1725 and 1727), and (iv) a 2-4 decoder neural network configuration unit configured with two activation functions f (1726 and 1728).

Each of the two activation functions (1721 and 1723) of the 2-1 decoder neural network configuration unit receives (i) the output value of the activation function f (1711) of the 1-1 decoder neural network and (ii) the output value of the activation function f (1713) of the 1-2 decoder neural network and applies the activation function to output them. Next, each of the two activation functions (1722 and 1724) of the 2-2 decoder neural network configuration unit receives (i) the output value of the activation function f (1712) of the 1-1 decoder neural network and (ii) the output value of the activation function f (1714) of the 1-2 decoder neural network and applies the activation function to output them. Additionally, each of the two activation functions (1725 and 1727) of the 2-3 decoder neural network configuration unit receives (i) the output value of the activation function f (1715) of the 1-3 decoder neural network and (ii) the output value of the activation function f (1717) of the 1-4 decoder neural network and applies the activation function to output them. Finally, each of the two activation functions (1726 and 1728) of the 2-4 decoder neural network configuration unit receives (i) the output value of the activation function f (1716) of the 1-3 decoder neural network and (ii) the output value of the activation function f (1718) of the 1-4 decoder neural network and applies the activation function to output them.

Looking at the form in which the activation functions configuring the second layer 1720 receive data from the first layer 1710, it can be seen that one input data is not input to all activation functions included in the second layer 1720, but only to some of all activation functions included in the second layer 1720. In other words, it can be described that the activation functions included in the second layer 1720 receive only some input values of all input values that can be input to each of the activation functions.

Finally, looking at the third layer (1730), the third layer is configured with (i) a 3-1 decoder neural network configuration unit configured with two activation functions f (1731 and 1735), (ii) a 3-2 decoder neural network configuration unit configured with two activation functions f (1732 and 1736), (iii) a 3-3 decoder neural network configuration unit configured with two activation functions f (1733 and 1737), and (iv) a 3-4 decoder neural network configuration unit configured with two activation functions f (1734 and 1738).

Each of the two activation functions (1731 and 1735) of the 3-1 decoder neural network configuration unit receives (i) the output value of the activation function f (1721) of the 2-1 decoder neural network and (ii) the output value of the activation function f (1725) of the 2-3 decoder neural network and applies the activation function to output them. Next, each of the two activation functions (1732 and 1736) of the 3-2 decoder neural network configuration unit receives (i) the output value of the activation function f (1722) of the 2-2 decoder neural network and (ii) the output value of the activation function f (1726) of the 2-4 decoder neural network and applies the activation function to output them. Additionally, each of the two activation functions (1733 and 1737) of the 3-3 decoder neural network configuration unit receives (i) the output value of the activation function f (1723) of the 2-1 decoder neural network and (ii) the output value of the activation function f (1727) of the 2-3 decoder neural network and applies the activation function to output them. Finally, each of the two activation functions (1734 and 1738) of the 3-4 decoder neural network configuration unit receives (i) the output value of the activation function f (1724) of the 2-2 decoder neural network and (ii) the output value of the activation function f (1728) of the 2-4 decoder neural network and applies the activation function to output them.

Looking at the form in which the activation functions configuring the third layer 1730 receive data from the second layer 1720, it can be seen that one input data is not input to all activation functions included in the third layer 1730, but only to some of all activation functions included in the third layer 1730. In other words, it can be described that the activation functions included in the third layer 1730 receive only some input values of all input values that can be input to each of the activation functions.

A process in which input data y1 to y8 (1701 and 1708) are input to the receiver encoder neural network and output as û1 to û8 (1741 and 1748) can be understood as a process in which input data y1 to y8 (1701 and 1708) are decoded.

To summarize the contents described in FIG. 17 above, it can be described that each of the activation functions included in the receiver decoder neural network receives only some input values of all input values that can be input to each of the activation functions.

In addition, in FIG. 17, for convenience of explanation, the case where the size of the input data block is 8 is described as an example, but the above description can be generalized to the case where the size of the input data block is 2K (K is an integer greater than 1). At this time, the receiver decoder neural network may be configured as K layers. Additionally, the K layers each may be configured as 2K−1 decoder neural network configuration units. Since the receiver decoder neural network is configured as K layers configured as 2K−1 decoder neural network configuration units, the total number of the decoder neural network configuration units configuring the receiver decoder neural network may be K*2k−1.

The structure of the receiver decoder neural network described in FIG. 17 can be applied at the transmitter. That is, the structure of the transmitter encoder neural network may be configured based on the method described in FIG. 17.

### Signaling Method—Proposal 3

The present proposal relates to a signaling method between the transmitter and the receiver according to the structure of the transmitter encoder neural network and the receiver decoder neural network.

When the receiver decoder neural network is configured based on the structure described in FIG. 15 above, decoding for the received signal in the receiver decoder neural network is performed based on Equations 6 and 7 above. Since Equations 6 and 7 include terms f1, f2, etc. related to the activation function that configures the transmitter encoder neural network, when performing decoding based on Equations 6 and 7, the receiver decoder neural network requires information on the weight values used in the transmitter encoder neural network. Therefore, after training of the transmitter encoder neural network and the receiver decoder neural network configuring the auto encoder is completed, the transmitter can transmit weight information used in the transmitter encoder neural network to the receiver. The training of the transmitter encoder neural network and the receiver decoder neural network may be performed at the transmitter or the receiver. When the training is performed at the transmitter, the transmitter may transmit weight information to be used in the receiver decoder neural network to the receiver. Conversely, if the training is performed at the receiver, since the receiver knows the weight information to be used in the receiver decoder neural network, there is no need to receive weight information to be used in the receiver decoder neural network from the transmitter.

When the receiver decoder neural network is configured based on the structure described in FIGS. 16 and 17 above, the transmitter must transmit weight information to be used in the receiver decoder neural network to the receiver. When the transmitter transmits weight information to be used in the receiver decoder neural network to the receiver, it may be the case where training of the transmitter encoder neural network and the receiver decoder neural network is performed at the transmitter.

In another method, when training about the transmitter encoder neural network and the receiver decoder neural network is performed at the receiver, the receiver may perform appropriately training about the transmitter encoder neural network based on capability, and calculate/determine/obtain weights to be used in the transmitter encoder neural network and transmit them to the transmitter.

Additionally, since information about the weights used in the transmitter encoder neural network can be transmitted to the receiver only when the structure of the receiver decoder neural network is configured as described in FIG. 15, the transmitter can decide whether to transmit information about the weights used in the transmitter encoder neural network according to the structure of the receiver decoder neural network. More specifically, the transmitter may receive structural information related to the structure of the receiver decoder neural network from the receiver. When (i) training about the transmitter encoder neural network and the receiver decoder neural network is performed at the transmitter, and (ii) the structure of the receiver decoder neural network indicated by the structure information is the structure described in FIG. 15 above, the transmitter may transmit weight information to be used in the receiver decoder neural network and weight information to be used in the transmitter encoder neural network to the receiver. Conversely, when (i) training about the transmitter encoder neural network and the receiver decoder neural network is performed at the transmitter, and (ii) the structure of the receiver decoder neural network indicated by the structure information is the structure described in FIGS. 16 and 17 above, the transmitter can transmit only weight information to be used in the receiver decoder neural network to the receiver. As above, since the transmitter can determine the information to be transmitted for decoding of the receiver according to the neural network structure of the receiver, unnecessary signaling overhead can be reduced.

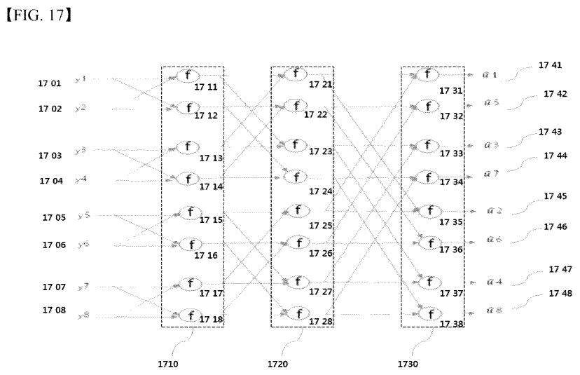

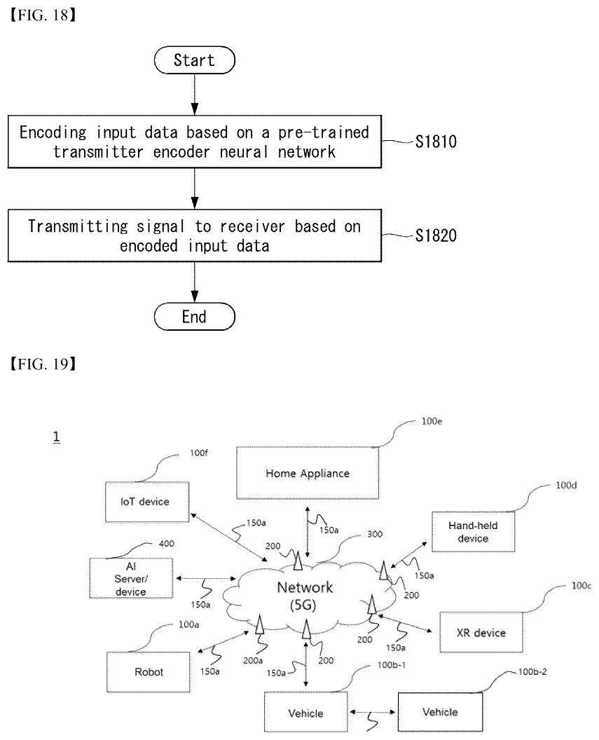

FIG. 18 is a flowchart illustrating an example of a method of transmitting and receiving a signal in a wireless communication system based on an auto encoder proposed in the present disclosure.

Referring to FIG. 18, the transmitter encodes at least one input data block based on a pre-trained transmitter encoder neural network (S1810).

Next, the transmitter transmits the signal to the receiver based on the encoded at least one input data block (S1820).

At this time, each of the activation functions included in the transmitter encoder neural network receives only some input values of all input values that can be input to each of the activation functions, and the transmitter encoder neural network is configured based on a neural network configuration unit that receives two input values and outputs two output values. Here, the neural network configuration unit is configured as the first activation function that receives both of the two input values and the second activation function that receives only one of the two input values. One of the two output values is output by multiplying the two input values by a weight applied to each of two paths through which the two input values are input into the first activation function, respectively and, applying the first activation function to sum of the two input values each multiplied by the weight. In addition, the other one of the two output values is output by multiplying the one input value by a weight applied to a path through which the one input value is input into the second activation function and, and applying the second activation function to one input value multiplied by the weight.

### Communication System Applied to Present Disclosure

The various descriptions, functions, procedures, proposals, methods, and/or operational flowcharts of the present disclosure described in this document may be applied to, without being limited to, a variety of fields requiring wireless communication/connection (e.g., 6G) between devices.

Hereinafter, a description will be certain in more detail with reference to the drawings. In the following drawings/description, the same reference symbols may denote the same or corresponding hardware blocks, software blocks, or functional blocks unless described otherwise.

FIG. 19 illustrates a communication system applied to the present disclosure.

Referring to FIG. 19, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

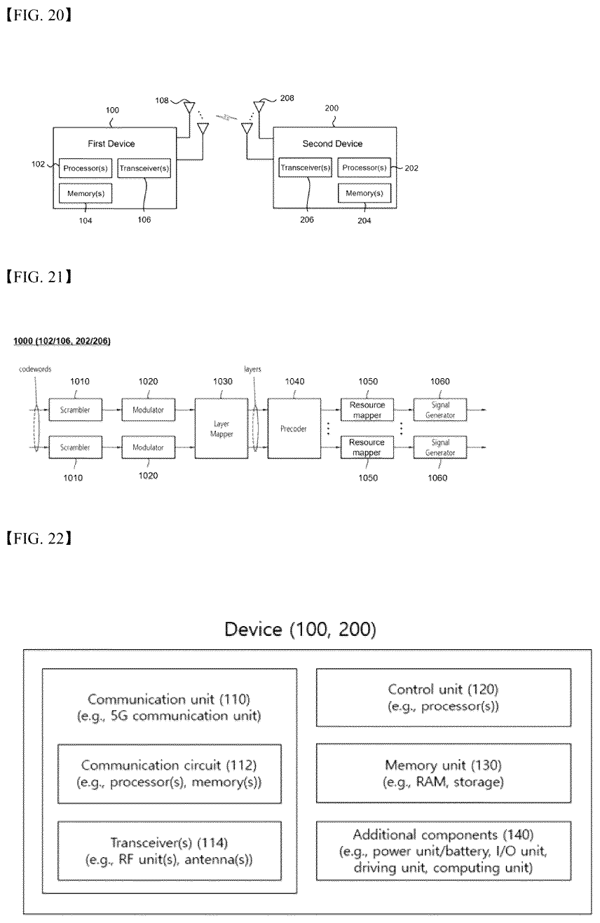

FIG. 20 illustrates wireless devices applicable to the present disclosure.

Referring to FIG. 20, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 19.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document.

FIG. 21 illustrates a signal process circuit for a transmission signal applied to the present disclosure.

Referring to FIG. 21, a signal processing circuit 1000 may include scramblers 1010, modulators 1020, a layer mapper 1030, a precoder 1040, resource mappers 1050, and signal generators 1060. An operation/function of FIG. 21 may be performed, without being limited to, the processors 102 and 202 and/or the transceivers 106 and 206 of FIG. 20. Hardware elements of FIG. 21 may be implemented by the processors 102 and 202 and/or the transceivers 106 and 206 of FIG. 20. For example, blocks 1010 to 1060 may be implemented by the processors 102 and 202 of FIG. 20. Alternatively, the blocks 1010 to 1050 may be implemented by the processors 102 and 202 of FIG. 20 and the block 1060 may be implemented by the transceivers 106 and 206 of FIG. 20.

Codewords may be converted into radio signals via the signal processing circuit 1000 of FIG. 21. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

Signal processing procedures for a signal received in the wireless device may be configured in a reverse manner of the signal processing procedures 1010 to 1060 of FIG. 21.

FIG. 22 illustrates another example of a wireless device applied to the present disclosure. The wireless device may be implemented in various forms according to a use-case/service.

Referring to FIG. 22, wireless devices 100 and 200 may correspond to the wireless devices 100 and 200 of FIG. 20 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 20. For example, the transceiver(s) 114 may include the one or more transceivers 106 and 206 and/or the one or more antennas 108 and 208 of FIG. 20. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 19), the vehicles (100b-1 and 100b-2 of FIG. 19), the XR device (100c of FIG. 19), the hand-held device (100d of FIG. 19), the home appliance (100e of FIG. 19), the IoT device (100f of FIG. 19), a digital broadcast terminal, a hologram device, a public safety device, an MTC device, a medicine device, a fintech device (or a finance device), a security device, a climate/environment device, the AI server/device (400 of FIG. 19), the BSs (200 of FIG. 19), a network node, etc. The wireless device may be used in a mobile or fixed place according to a use-example/service.

Hereinafter, the implementation example of FIG. 22 will be described in more detail with reference to the drawings.

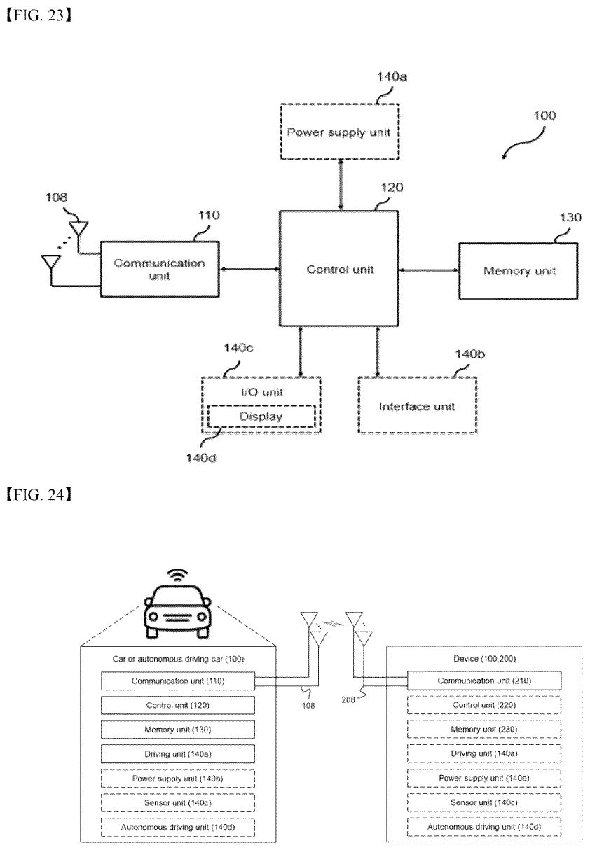

FIG. 23 illustrates a hand-held device applied to the present disclosure.

Referring to FIG. 23, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 34, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

FIG. 24 illustrates a vehicle or an autonomous driving vehicle applied to the present invention. The vehicle or autonomous driving vehicle may be implemented by a mobile robot, a car, a train, a manned/unmanned Aerial Vehicle (AV), a ship, etc.

Referring to FIG. 24, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 22, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

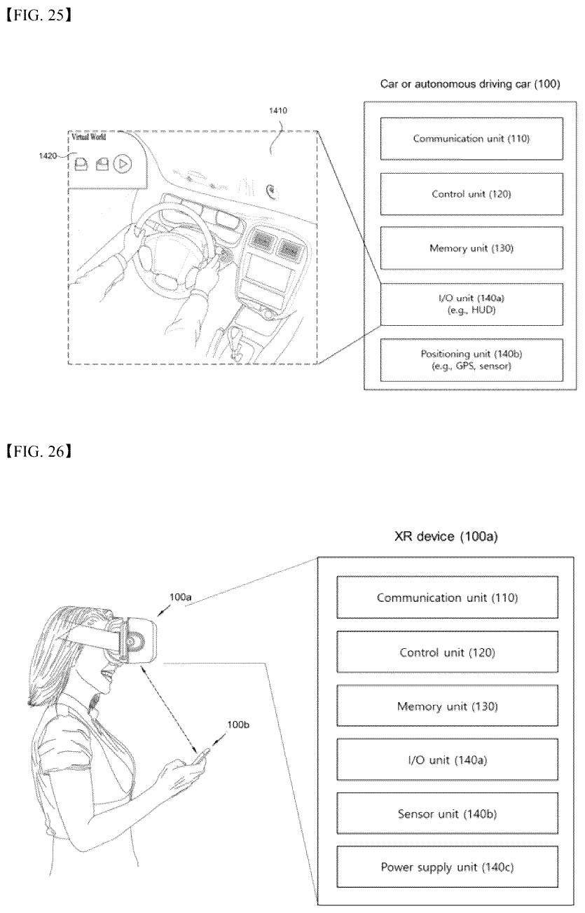

FIG. 25 illustrates a vehicle applied to the present disclosure. The vehicle may be implemented as a transport means, an aerial vehicle, a ship, etc.

Referring to FIG. 25, a vehicle 100 may include a communication unit 110, a control unit 120, a memory unit 130, an I/O unit 140a, and a positioning unit 140b. Herein, the blocks 110 to 130/140a and 140b correspond to blocks 110 to 130/140 of FIG. 22.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

FIG. 26 illustrates an XR device applied to the present invention. The XR device may be implemented by an HMD, an HUD mounted in a vehicle, a television, a smartphone, a computer, a wearable device, a home appliance, a digital signage, a vehicle, a robot, etc.

Referring to FIG. 26, an XR device 100a may include a communication unit 110, a control unit 120, a memory unit 130, an I/O unit 140a, a sensor unit 140b, and a power supply unit 140c. Herein, the blocks 110 to 130/140a to 140c correspond to the blocks 110 to 130/140 of FIG. 22, respectively.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

Furthermore, The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

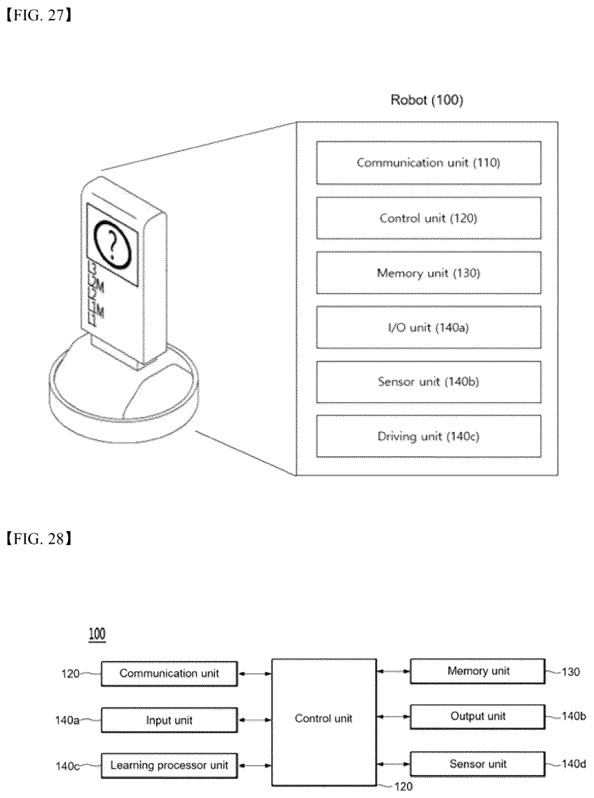

FIG. 27 illustrates a robot applied to the present invention. The robot may be categorized into an industrial robot, a medical robot, a household robot, a military robot, etc., according to a used purpose or field.

Referring to FIG. 27, a robot 100 may include a communication unit 110, a control unit 120, a memory unit 130, an I/O unit 140a, a sensor unit 140b, and a driving unit 140c. Herein, the blocks 110 to 130/140a to 140c correspond to the blocks 110 to 130/140 of FIG. 22, respectively.

The communication unit 110 may transmit and receive signals (e.g., driving information and control signals) to and from external devices such as other wireless devices, other robots, or control servers. The control unit 120 may perform various operations by controlling constituent elements of the robot 100. The memory unit 130 may store data/parameters/programs/code/commands for supporting various functions of the robot 100. The I/O unit 140a may obtain information from the exterior of the robot 100 and output information to the exterior of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may cause the robot 100 to travel on the road or to fly. The driving unit 140c may include an actuator, a motor, a wheel, a brake, a propeller, etc.

FIG. 28 illustrates an AI device applied to the present invention. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 28, an AI device 100 may include a communication unit 110, a control unit 120, a memory unit 130, an I/O unit 140a/140b, a learning processor unit 140c, and a sensor unit 140d. The blocks 110 to 130/140a to 140d correspond to blocks 110 to 130/140 of FIG. 22, respectively.

The communication unit 110 may transmit and receive wired/radio signals (e.g., sensor information, user input, learning models, or control signals) to and from external devices such as other AI devices (e.g., 100x, 200, or 400 of FIG. W1) or an AI server (e.g., 400 of FIG. W1) using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information which is determined or generated using a data analysis algorithm or a machine learning algorithm. The control unit 120 may perform an operation determined by controlling constituent elements of the AI device 100.

The memory unit 130 may store data for supporting various functions of the AI device 100.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. W1). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

In the aforementioned embodiments, the elements and characteristics of the present disclosure have been combined in a specific form. Each of the elements or characteristics may be considered to be optional unless otherwise described explicitly. Each of the elements or characteristics may be implemented in a form to be not combined with other elements or characteristics. Furthermore, some of the elements or the characteristics may be combined to form an embodiment of the present disclosure. The sequence of the operations described in the embodiments of the present disclosure may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the present disclosure may be implemented by various means, for example, hardware, firmware, software or a combination of them. In the case of an implementation by hardware, the embodiment of the present disclosure may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present disclosure may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present disclosure may be materialized in other specific forms without departing from the essential characteristics of the present disclosure. Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure.

### INDUSTRIAL APPLICABILITY

The present disclosure has been described focusing on examples applied to 3GPP LTE/LTE-A and 5G systems, but it can be applied to various wireless communication systems in addition to the 3GPP LTE/LTE-A and 5G systems.

1. A method of transmitting a signal in a wireless communication system based on an auto encoder, the method performed by a transmitter comprising:
encoding at least one input data block based on a pre-trained transmitter encoder neural network; and
transmitting the signal to a receiver based on the encoded at least one input data block,
wherein each of activation functions included in the transmitter encoder neural network receives only some input values of all input values that can be input into each of the activation functions,
the transmitter encoder neural network is configured based on a neural network configuration unit that receives two input values and outputs two output values,
the neural network configuration unit includes a first activation function that receives both of the two input values and a second activation function that receives only one of the two input values,
one of the two output values is output by multiplying the two input values by a weight applied to each of two paths through which the two input values are input into the first activation function, respectively and, applying the first activation function to sum of the two input values each multiplied by the weight, and
the other one of the two output values is output by multiplying the one input value by a weight applied to a path through which the one input value is input into the second activation function and, and applying the second activation function to one input value multiplied by the weight.

2. The method of claim 1, wherein a number of the neural network configuration unit configuring the transmitter encoder neural network is determined based on a number of the at least one input data block.

3. The method of claim 2, wherein, when the number of the at least one input data block is 2K, the transmitter encoder neural network is configured as K layers,
the K layers each is configured as 2K−1 neural network units, and
the K is an integer of 1 or more.

4. The method of claim 3, wherein the number of the neural network configuration unit configuring the transmitter encoder neural network is K*2k−1.

5. The method of claim 1, wherein the first activation function and the second activation function are the same function.

6. The method of claim 5, wherein an output value of each of the first activation function and the second activation function is determined as one of a specific number of quantized values.

7. The method of claim 1, wherein the first activation function and the second activation function are different functions,
$$f 2 ( x ) = x \qquad [ equation ]$$
where, the second activation function is a function that satisfies the above equation.

8. The method of claim 1, further comprising:
training the transmitter encoder neural network and a receiver decoder neural network configuring the auto encoder.

9. The method of claim 8, further comprising:
transmitting information for decoding in the receiver decoder neural network to the receiver based on the training being performed at the transmitter.

10. The method of claim 9, further comprising:
receiving structural information related to a structure of the receiver decoder neural network from the receiver,
based on the structural information, the information for decoding in the receiver decoder neural network includes (i) receiver weight information used for the decoding in the receiver decoder neural network, or (ii) transmitter weight information for the receiver weight information and for weights used for encoding in the transmitter encoder neural network.

11. The method of claim 10, wherein, based on that the structure of the receiver decoder neural network indicated by the structure information is a first structure configured to receive only some input values of all input values that each of receiver activation functions included in the receiver decoder neural network can be input to each of the receiver activation functions, the information for decoding in the receiver decoder neural network includes the receiver weight information, and
based on that the structure of the receiver decoder neural network indicated by the structure information is a second structure configured based on a plurality of decoder neural network configuration units, which is each performing decoding, for some data blocks configuring an entire data block received from the receiver decoder neural network, the information for decoding in the receiver decoder neural network includes the receiver weight information and the transmitter weight information.

12. The method of claim 8, wherein, based on the training, a value of the weight applied to each of the two paths through which the two input values are input into the first activation function and a value of the weight applied to the path through which the one input value is input into the second activation function are trained.

13. A transmitter configured to transmit and receive a signal in a wireless communication system based on an auto encoder, the transmitter comprising:
a transmitter configured to transmit a wireless signal;
a receiver configured to receive a wireless signal;
at least one processor; and
at least one memory operably connected to the at least one processor, and storing instructions for performing operations when on being executed by the at least one processor,
wherein the operations includes:
encoding at least one input data block based on a pre-trained transmitter encoder neural network; and
transmitting the signal to a receiver based on the encoded at least one input data block,
wherein each of activation functions included in the transmitter encoder neural network receives only some input values of all input values that can be input into each of the activation functions,
the transmitter encoder neural network is configured based on a neural network configuration unit that receives two input values and outputs two output values,
the neural network configuration unit includes a first activation function that receives both of the two input values and a second activation function that receives only one of the two input values,
one of the two output values is output by multiplying the two input values by a weight applied to each of two paths through which the two input values are input into the first activation function, respectively and, applying the first activation function to sum of the two input values each multiplied by the weight, and
the other one of the two output values is output by multiplying the one input value by a weight applied to a path through which the one input value is input into the second activation function and, and applying the second activation function to one input value multiplied by the weight.

14. (canceled)

15. A receiver configured to transmit and receive a signal in a wireless communication system based on an auto encoder, the receiver comprising:
a transmitter configured to transmit a wireless signal;
a receiver configured to receive a wireless signal;
at least one processor; and
at least one computer memory operably connected to the at least one processor, and storing instructions for performing operations when being executed by the at least one processor,
wherein the operations includes:
receiving a signal generated based on at least one input data block encoded based on a pre-trained transmitter encoder neural network from a transmitter; and
decoding the received signal,
wherein a structure of a receiver decoder neural network is one of (i) a first structure in which each of activation functions included in the receiver decoder neural network receives only some input values of all input values that can be input into each of the activation functions and (ii) a second structure configured based on a plurality of decoder neural network configuration units that each perform decoding for some data blocks configuring the encoded at least one input data block received from the receiver decoder neural network,
the receiver decoder neural network configured in the first structure is configured based on a decoder neural network configuration unit that receives two input values and outputs two output values,
the decoder neural network configuration unit includes two activation functions that receive both of the two input values,
one of the two output values is output by multiplying the two input values by a weight applied to each of two paths through which the two input values are input into the first activation function, which is one of the two activation functions, respectively and, applying the first activation function to sum of the two input values each multiplied by the weight, and
the other one of the two output values is output by multiplying the two input value by a weight applied to each of two path through which the two input value are input into the second activation function, which is one of the two activation functions, respectively and, applying the second activation function to sum of the two input values each multiplied by the weight.

16-17. (canceled)
